(19) United States
(12) Patent Application Publication
(10) Pub. No.: US 2003/0182051 A1
(43) Pub. Date: Sep. 25, 2003

(54) Road traffic information transmitter, transmitting method, transmitting program, and road traffic information receiver, receiving method, and reception program

(75) Inventor: Tetsuo Yamamoto, Tokyo (JP)

Correspondence Address: CARRIER BLACKMAN AND ASSOCIATES, 24101 NOVI ROAD, SUITE 100, NOVI, MI, 48375

(73) Assignee: VEHICLE INFORMATION AND COMMUNICATION SYSTEM CENTER, Tokyo (JP)

(21) Appl. No.: 10/392,136

(22) Filed: Mar. 19, 2003

(30) Foreign Application Priority Data
Mar. 20, 2002 (JP) 2002-079461
Mar. 7, 2003 (JP) 2003-60950

(51) Int. Cl. G01C 21/26

(52) U.S. Cl. 701/200; 340/995.13

(57) ABSTRACT

A road information transmitter, its method, its program and a road information receiver, its method, its program capable of reducing the data-transmission amount of road information are provided, wherein it is not necessary to have the newest database corresponding to the VICS link. The road information receiver 5 to receive the road information transmitter 3 for transmitting the road information containing traffic data showing location data for showing the position of a road, and traffic data for showing traffic condition of the road, wherein the road information transmitter 3 includes traffic data collection part 7, element coordinates records department 9, encoding part 11, modulation part 13, and transmitter 15, wherein the road information receiver 5 includes receiving part 17, demodulation part 19, decoding part 21, map coordinates data records department 23, road specification processing part 25, and traffic data-processing part 27.

### TECHNICAL FIELD OF THE INVENTION

This invention relates to a road traffic information transmitter, a road traffic information transmitting method, a road traffic information transmitting program and a road traffic information receiver, a road traffic information receiving method, and a road traffic information reception program, for transmitting and receiving the traffic information that indicates the position of a road

### BACKGROUND OF THE INVENTION

Generally location data, which divides a road at the main crossings of the road and attaches the number thereto, and a traffic data showing a traffic condition (the number of vehicles that have passed, traffic congestion information, information about a traffic accident and traffic regulation, and the like) of the road detected by a sensor set up on the road, are correlated. Then obtained road information is transmitted from a transmitting side (a transmitter for collecting and transmitting traffic data) to a receiving side (a receiver provided in moving objects such as vehicles) to indicate the position of the road, and VICS (Vehicle Information and Communication System)) which notifies the driver (a passenger, user) who operates moving objects such as vehicles, of the traffic condition of the road, is known (see JP-A-2003-4466, for example.).

Location data in the vehicle information and communication system (VICS) is referred to as the VICS link, which serves to facilitate the correlation of the road information specified by a unique number with the traffic data providing information on the traffic condition of the road. Therefore, efficient transmission of information can be achieved, so that a large amount of information can be transmitted in a narrow bandwidth.

By the way, this VICS link adopts a latitude longitude system, to show the position of a road. When showing the position of one road with this latitude longitude system, two or more numerical values of 10 or more digits are required. When transmitting these numerical values by the amount corresponding to the number of roads to a reception side from a transmission side, data-transmission amount becomes huge. In order to reduce this data-transmission amount, the VICS link roads are divided into sections and the VICS link is defined for every section.

However, vehicle information and communication system (VICS) must redefine the VICS link, when a change is made in road topology, or when the traffic data collected by a sensor set up on the road is changed. This poses a problem that defining and creating the VICS link involves time and labor.

Moreover, when the position of a road is indicated using this VICS link, if the receiver of the reception side is not equipped with a newest database (corresponding to the change of a road or the like.) (map coordinates database, link database) corresponding to the VICS link, there arises a problem that the position of a road cannot be indicated.

Furthermore, there arises a problem that it takes two to three years for the map coordinates database and the link database to be updated so as to correspond to the change of the road and to reach the drivers driving a vehicle or other moving objects. Furthermore, even when the driver and the like purchases the on-board machine (receiver) capable of updating these databases, about 10,000 to 30,000 yen burden is involved in updating the link database. The old data of the VICS link before updating is also transmitted for three years from a transmission side, posing the problem that the data-transmission amount to transmit is increased.

Hereupon, an object of the present invention resides in providing a road traffic information transmitter, a road traffic information transmitting method, a road traffic information transmitting program and a road traffic information receiver, a road traffic information receiving method, and a road traffic information reception program, capable of reducing the data-transmission amount of the road traffic information transmitted to a reception side from a transmission side, solving the problem involved in the related art without defining the VICS link, without a necessity to have a newest database corresponding to the VICS link in the receiving side.

### SUMMARY OF THE INVENTION

In order to overcome the above problem, this invention is constituted as described below.

A road information transmitter including location data showing the position of a road includes an element coordinates recode part, an encoding part, a modulation part, and a transmitting part.

A road information transmitter including location data showing the position of a road and a traffic data showing the traffic condition of the road includes a traffic data collecting part, an element coordinates recode part, an encoding part, a modulation part, and a transmitting part.

A road information transmitting method for transmitting the road information including the location data to show the position of the road includes an encoding step, a modulation step, and a transmitting step.

A road information transmitting method for transmitting the road information including traffic data showing the location data showing the position of the road and traffic condition of the road includes a traffic data collecting step, an encoding step, a modulation step, and a transmitting step.

A road information transmitting program functionally includes an encoding part, a modulation part, and a transmitting part as devices for transmitting the road information including the location data showing the position on the road.

A road information transmitting program having a part for transmitting a road information including location data showing the position of a road, and traffic data showing the traffic condition of the road, is functionally formed into a traffic data collecting part, an encoding part, a modulation part, and a transmitting part.

A road information receiver for receiving the modulation signal transmitted from a road information transmitter as road information, and indicating the position of a road includes a receiving part, a decoding part, a decoded coordinates generation part, a map coordinates data recode part, and a road specification processing part.

A road information receiver for outputting the processing information processed based on traffic data included in the road information while receiving the road information transmitted from the road information transmitter, and indicating the position of the road includes a receiving part, a decoding part, a decoded coordinates generation part, a map coordinates data recode part, a road specification processing part, and a traffic data-processing part.

A road information receiving method for receiving the modulation signal transmitted as road information by the road information transmitting method, and indicating the position of a road includes a receiving step, a decoding step, a decoded coordinates generation step, and a road specification processing step.

A road information receiving method for outputting the processing information processed based on traffic data included in the road information, while receiving road information transmitted by the road information transmitting method and indicating the position of a road includes a receiving step, a decoding step, a decoded coordinates generation step, a road specification processing step, and a traffic data-processing step.

A road information reception program functionally includes devices such as a receiving part, a decoding part, a decoded coordinates generation part, and a road specification processing part, for indicating the position on the road, by receiving the modulation signal transmitted as a road information, when the road information transmitting program functions.

A road information receiving program functionally includes devices such as a receiving part, a decoding part, a decoded coordinates generation part, a road specification processing part, and a traffic data-processing part, for outputting the processing information processed on the base of the traffic data included in the road information, while specifying the position on the road by the received road information transmitted when the road information transmitting program functions.

### BRIEF DESCRIPTION OF THE DRAWINGS

FIG. 1 is a block diagram of Vehicle Information and Communication System, which is one embodiment of this invention.

FIG. 2 is a flow chart explaining the operation of a road information transmitter.

FIG. 3 is a flow chart explaining the operation of a road information receiver.

FIG. 4 is a view explaining the data structure when element coordinates and traffic data are correlated.

FIG. 5 is a view explaining the details of location data portion.

FIG. 6 is a view explaining details of “An angle flag (1 bit)” and “an angle (6 bits or 8 bits)”.

FIG. 7 is a view explaining the details of “A length flag (1 bit)” and details of “length (6 bits or 8 bits)”.

FIG. 8 is a view explaining details of a traffic data portion.

FIG. 9 is a view explaining details of “a travel time (8 bits).”

FIG. 10 is a view explaining element coordinates recorded in the element coordinates recodes department.

FIG. 11 is a view explaining the element coordinates displayed on a display screen of a display output part.

FIG. 12 is a view explaining changes in mentioning the element coordinates.

FIG. 13 is a view explaining one of the “frame” when classified in a secondary mesh.

FIG. 14 is a flow chart explaining the procedure of the creation process of the element coordinates, which creates the element coordinates from map coordinates.

FIG. 15 is a flow chart explaining a method for a setup of a middle point node (interpolation point).

FIG. 16 is a view explaining about the cause of an error of the element coordinates and its management.

FIG. 17 is a view explaining about misjudged distance of a road and calculation of the misjudged direction.

FIG. 18 is a view explaining about coordinates correction in the opposite direction.

FIG. 19 is a view explaining about matching with the element coordinates and a road drawn by map coordinates data.

FIG. 20 is a flow chart explaining about processing to indicate the position on the road.

FIG. 21 is a view showing a road drawn by decoded coordinates and a road drawn by a map coordinates data recorded in a map coordinates data recodes department.

FIG. 22 is a view showing an example of traffic congestion information (traffic congestion data).

FIG. 23 is a view schematically showing a road where the degree of traffic congestion differs in each section, and pluralities of roads, which intersect this road.

FIG. 24 is a view showing a road, the position of which is indicated on a reproduction coordinates and traffic congestion information on this road (traffic congestion data) in a corresponding manner.

FIG. 25 is a view showing overall traffic congestion information (traffic congestion data) included in traffic data on Table.

FIG. 26 is a view explaining the case where the number of the traffic congestion information (traffic congestion data) in connection with a link is one.

FIG. 27 is a view explaining the case where the number of the traffic congestion information (traffic congestion data) in connection with a link is two.

FIG. 28 is a view explaining the case where the traffic congestion information (traffic congestion data) in connection with a link is three or more.

FIG. 29 is a view showing a link where the time required is demanded, and traffic congestion information (traffic congestion data) in connection with this link.

FIG. 30 is a view showing an example of the traffic congestion information (traffic congestion data) processed in the road specification processing part and traffic data-processing part of the reception (generation) side.

FIG. 31 is a flow chart explaining how to find the time required from traffic congestion information (traffic congestion data) to reproduction coordinates (node) (link Li).

FIG. 32 is a view showing the result of comparison where the road information transmission and reception system, and the present system (VICS) are compared in data-transmission amount.

FIG. 33 is a view explaining the result of comparison where each information on various systems for encoding traffic congestion information (traffic congestion data) using the normalized coordinates of secondary mesh units, and the amount of information are compared.

### PREFERRED EMBODIMENT OF THE INVENTION

Hereafter, one embodiment of this invention will be explained in detail in conjunction with the drawings.

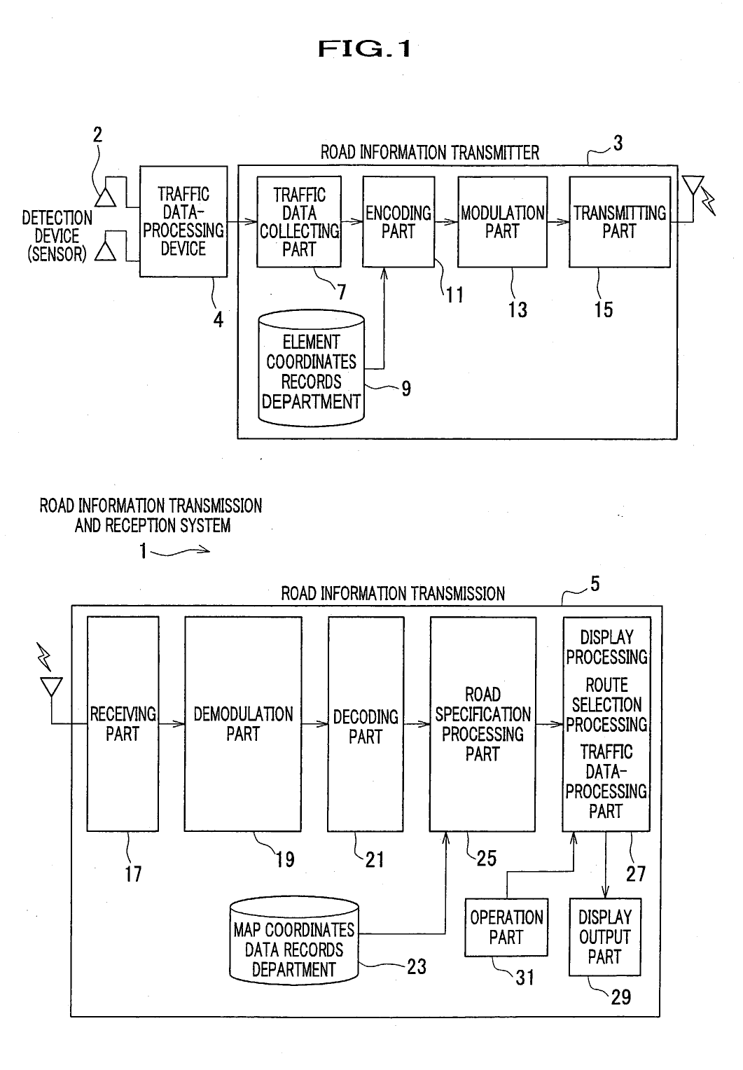

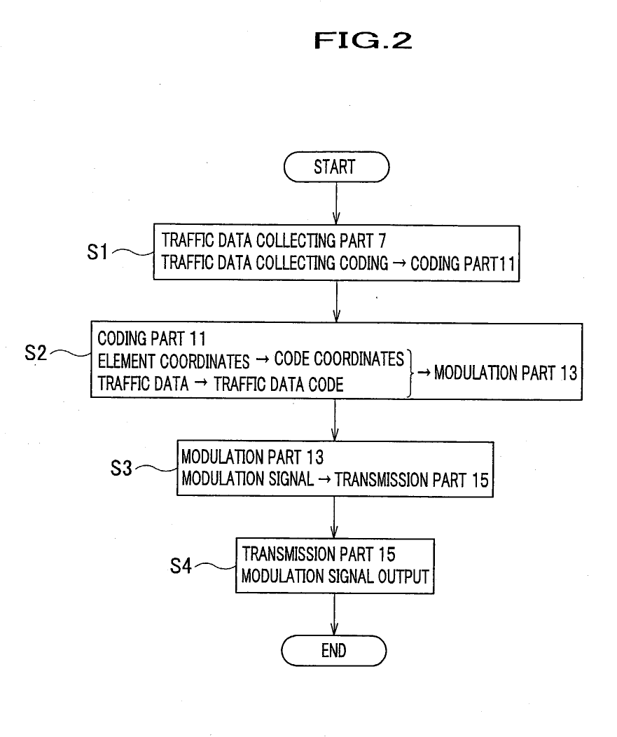

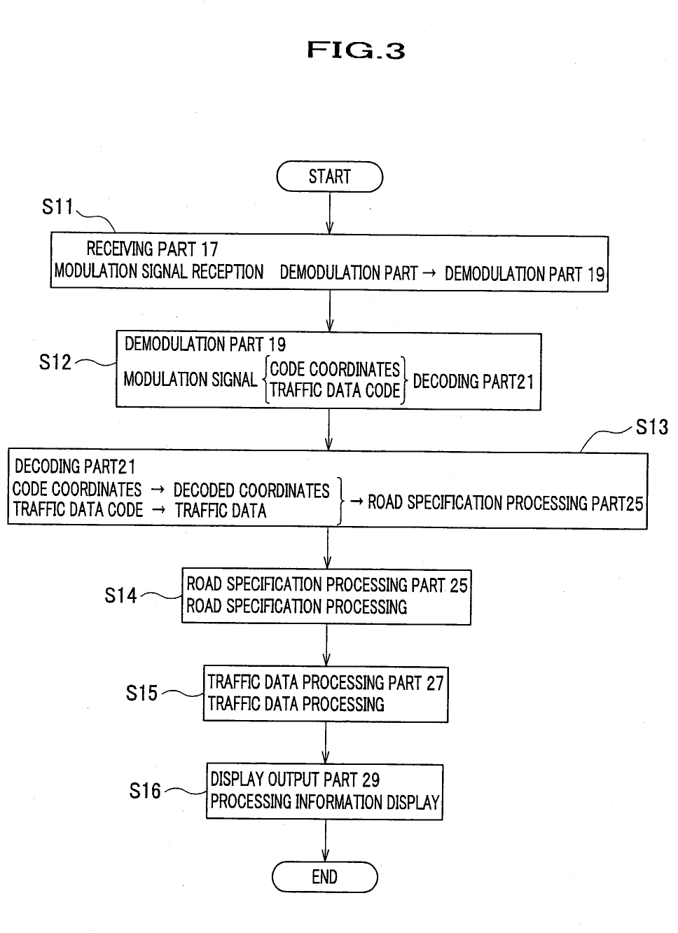

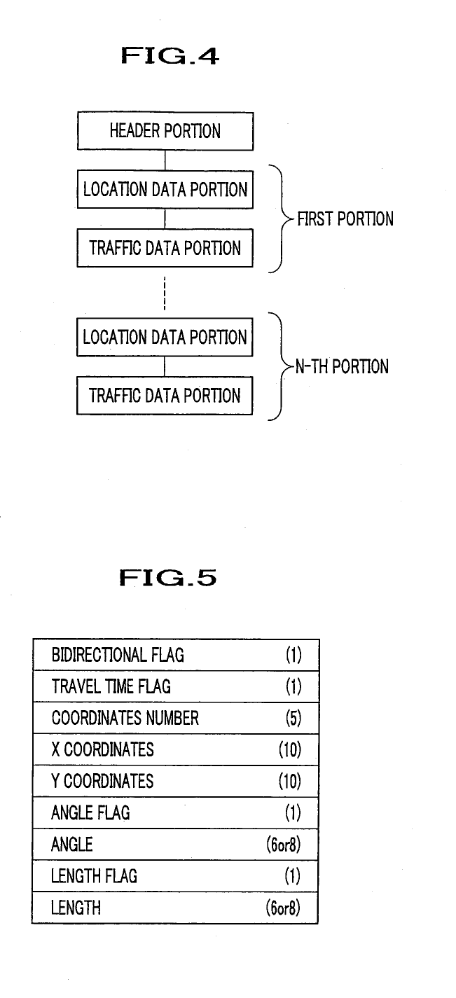

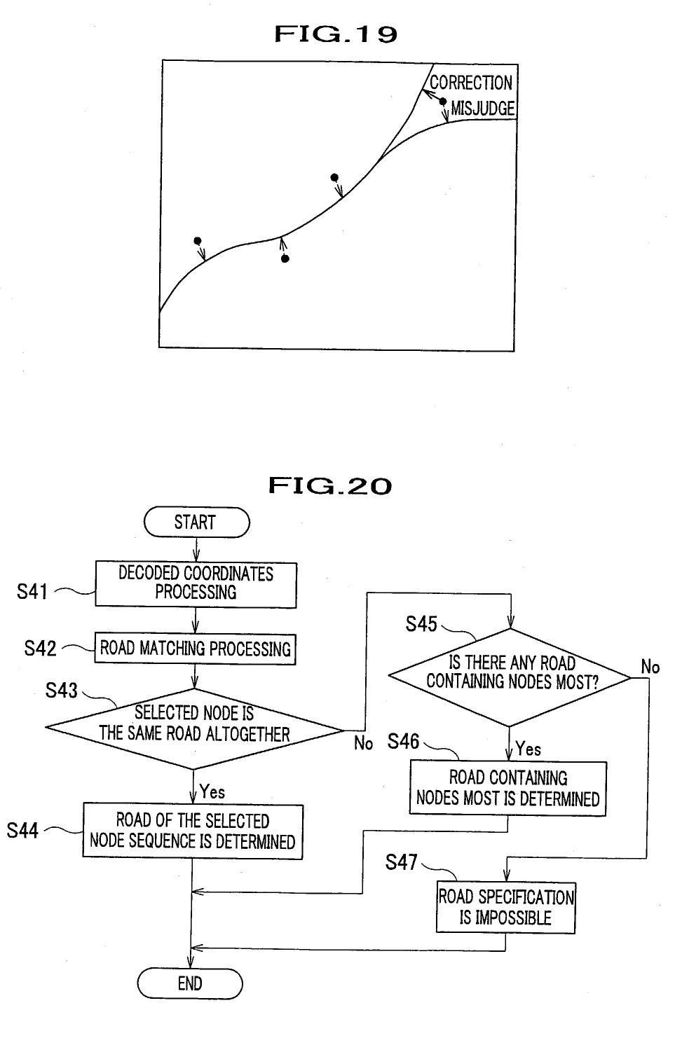

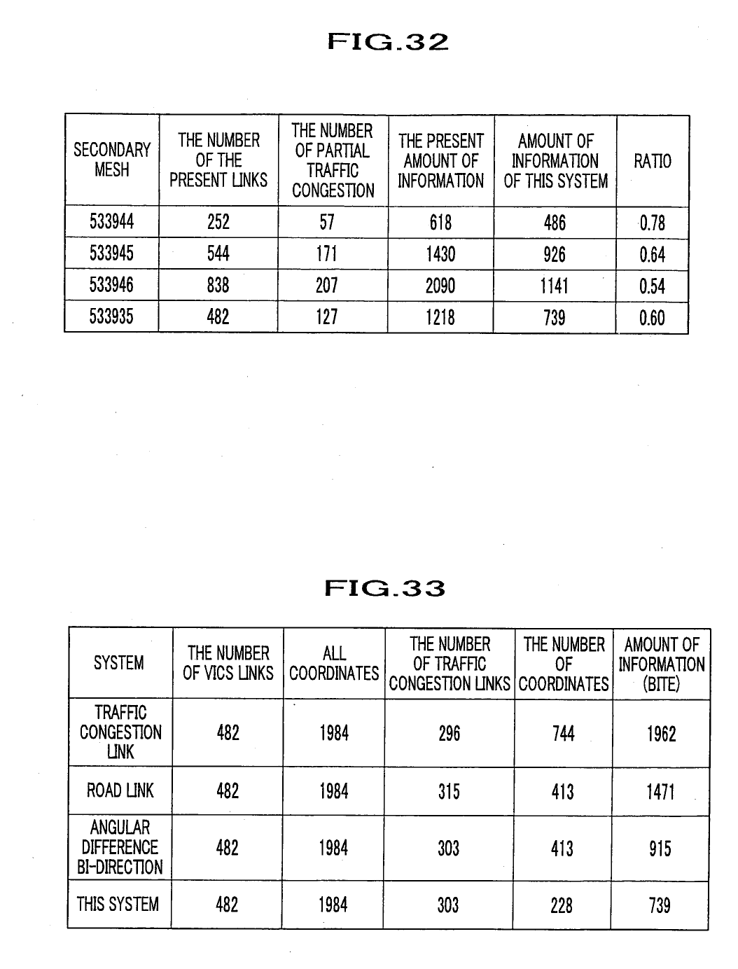

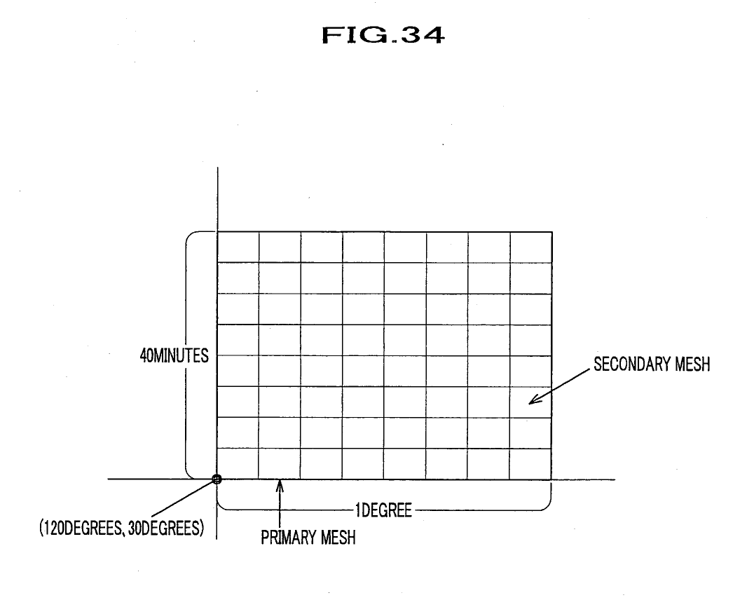

First, the constitution of the road information transmission and reception system (road information transmitter and pluralities of road information receiver) (FIG. 1), then operation of the road information transmitter (FIG. 2), and operation of the road information receiver (FIG. 3) will be explained. Then the road information will be explained (FIG. 4 to FIG. 9), and element coordinates will be explained (FIG. 10 to FIG. 18). Moreover, in the road information receiver of the reception side, how to indicate the road will be explained (FIG. 19 to FIG. 21), and processing of traffic data will be explained (FIG. 22 to FIG. 31). The result of comparison compared with the present system (VICS) and various encoding systems is explained (FIG. 32, FIG. 33). Further, supplementary explanation will be given about the secondary mesh. (FIG. 34).

(Road Information Transmission and Reception System)

FIG. 1 is a block diagram of a road information transmission and reception system. As shown in the FIG. 1, the road information transmission and reception system 1 transmits location data for indicating the position of a road, and traffic data showing the traffic condition of the road, as road information, and can grasp the position and traffic condition of the road at a reception side, wherein road information transmitter 3 and road information receiver 5 are included.

As shown in FIG. 1, detection part 2 and traffic data-processing part 4 for transmitting traffic data to the road information transmitter 3 are included.

Detection part 2 is set up for every fixed section (for example for every main crossings) on each road (a road side end, passage gate of the road, or the like.), and detects the speed of vehicles and the number of vehicles, which passed through the road.

Traffic data-processing device 4 correlates the speed of vehicles and the number of vehicles, which were detected at detection part 2, and ID (referred to as the road section ID hereafter) attached in order to identify the fixed section of each road, and generates a traffic data for every road section identified by the road section ID. It can be said that this traffic data shows a congestion state of the fixed section (passage number of the vehicles per fixed time), and is so-called traffic congestion information (traffic congestion data). Moreover, this traffic data-processing device 4 accumulates construction information, traffic accident information (regulation data showing traffic restriction of the road), and the like on the road, which are brought about by the Metropolitan Police Department and the like. The information is also included in the traffic data.

In addition, the road section ID corresponds to the conventional VICS system (adopted still now) so as to cooperate with the conventional VICS system in Japan. However it is not necessarily correspond to this VICS link. For example, the road section division corresponding to the road state of an every place region (each country) is set up beforehand, and the speed of vehicles and the number of vehicles are detected for the every road section. Then this may be called as traffic data. Or the speed of vehicles and the number of vehicles are detected not for every road section but for every road (for example, from a point of a national highway No.29 up to b point). And this may also be the traffic data.

[Constitution of a Road Information Transmitter]

Road information transmitter 3 uses the element coordinates as location data which indicate the position of the road, transmits the road information associated with this location data and the traffic data processed at traffic data-processing device 4 to the road information receiver 5 of the reception side, wherein traffic data collecting part 7, element coordinates recodes department 9, encoding part 11, modulation part 13, and transmitting part 15 are included.

The traffic data collecting part 7 collects the traffic data processed at traffic data-processing device 4 through a network, or by receiving a broadcast wave, and the traffic data is outputted to the encoding part 11. This traffic data collecting part 7 is connected on a network in addition to the traffic data processed at the traffic data-processing part 4, and the server which offers traffic data is accessed at intervals of fixed time (for example, every 1 minute), and the newest traffic data is always collected. This traffic data collecting part 7 is equivalent to the traffic data collecting part as described in the claims.

Element coordinates recodes department 9 recorded the element coordinates extracted at least arbitrary two points for indicating the position of the road beforehand from the map coordinates data capable of indicating the position by coordinates. Map coordinates data classifies the geographical feature on surface of the earth in a secondary mesh (7.5 min×5 min in longitude and latitude, and about 10000 m×10000 m frame in length, as will be detailed hereafter), and allocates coordinates (normalized coordinates (for example, [x-coordinates of about 0-10000 and the y coordinates of about 0-10000])) to the every one classified “frame” (Rectangle). The element coordinates recordes department 9 is equivalent to the element coordinates recorde part as described in the claims.

In addition, element coordinates can indicate the position of the road by at least two coordinates (origin, destination) in the map coordinates data for indicating the position. Wherein correct indicating of the position of the road is possible by providing an optimal interpolation point according to the number of the crookedness when the road is crooked intricately. For example, in case of the road crooked right-angled only once, the position of the road can be correctly indicated by setting the interpolation point at this right-angled point, to thereby indicate the position of the road by the origin, the destination, and the interpolation point (these are referred to as “node” (a knot, intersection)). In addition, data (name data) where the name of the road is shown is added to these element coordinates. Detailed description of the element coordinates will be described hereafter (it will be explained in full detail using FIG. 10 to FIG. 18).

Encoding part 11 associates the traffic data collected in traffic data collecting part 7, and the element coordinates recorded in the element coordinates recorde means 9, to obtain road information, encodes this road information, and outputs it to the modulation part 13. This encoding part 11 associates each of the traffic data and element coordinates based on the road section ID included in the traffic data, and the position of the road indicated by element coordinates.

Moreover, by encoding of the road information in this encoding part 11, the amount of information is decreased for transmission, element coordinates are encoded into code coordinates and traffic data is encoded into a traffic data code. These encoded coordinates and traffic data codes are united, to obtain encoded road information. In addition, details of this road information will be explained hereafter (it will be explained in full detail using FIG. 4 to FIG. 9).

Modulation part 13 performs a digital modulation of the road information (encoded road information) encoded in the encoding part 11, and outputs it to the transmitting part 15 as a modulation signal. This modulation part 13 is equivalent to the modulation part as described in the claims.

Transmitting part 15 is a transmitter for applying power amplification of the modulation signal where the digital modulation was applied in the modulation part 13, and this amplified modulation signal is transmitted (broadcasted) from an antenna as road information. That is, the road information which indicates the position of each road is defined with this road information transmitter 3 by two element coordinates of origin and destination at least. Therefore, the amount of information_transmitted by pluralities of VICS links can be lessened compared with the road information, which indicates the position of each road like the conventional VICS system. Moreover, even if the length of the road, the method for connecting the road, the name of the road and the like are changed, it is not necessary to define the VICS link but just change the element coordinates. Moreover, data-transmission amount is reducible by transmitting the code coordinates encoded in the encoding part 11 of road information transmitter 3 to the road information receiver 5 of the reception side (as road information modulated and applied power amplification).

Moreover, according to this road information transmitter 3, in the traffic data collecting part 7, traffic data is collected, the element coordinates and traffic data which are recorded in the element coordinates recordes department 9 in the encoding part 11 are associated, and encoded into code coordinates and traffic data codes. And the code coordinates and the traffic data codes are modulated by the modulation signal in the modulation part 13, and this modulation signal is transmitted as road information in the transmitting part 15. That is, according to this road information transmitting equipment 3, the traffic data processed at traffic data-processing equipment 4 is correlated with the element coordinates which indicate the position of the road, and transmitted as road information, and the VICS link is not used for indicating the position of the road. That is, the road information_which indicates the position of each road is defined by two element coordinates of origin and destination at least, without being dependent on the VICS link. Therefore, there can be little amount of information, which indicates the position of the road, and the traffic condition of the road section with position specified by element coordinates, can be transmitted in small amount.

Furthermore, production (definition) of the VICS link, distribution of the newest database corresponding to the VICS link, and the like can reduce maintenance cost sharply by the road information which indicates the position of each road defined by two element coordinates of origin and destination at least. Therefore the mobile power of transfer of the road information can be improved, and the convenience of the user (who needs the road information) who uses the road information transmission and reception system 1 can be raised remarkably.

[Constitution of a Road Information Receiver]

Road information receiver 5 is provided for grasping the traffic condition of the road, and is equipped with receiving part 17, demodulation part 19, decoding part 21, map coordinates data recordes department 23, road specification processing part 25, traffic data-processing part 27, display output part 29, and operation part 31 while receiving the road information transmitted from the road information transmitter 3 of the transmission side and indicating the position of the road. In addition, moving objects, such as vehicles, are provided with this road information receiver 5. However adaptation can be widened to a common residence and the like, which is not needed to move, for example.

Receiving part 17 receives, detects electricity and applies power amplification through an antenna, and outputs the road information (modulation signal) transmitted from road information transmitter 3 to the demodulation part 19.

The demodulation part 19 applies the digital demodulation of the road information (modulation signal) received at the receiving part 17, and collects encoded road information (code coordinates and traffic data code). That is, this demodulation part 19 changes the modulation signal transmitted from the road information transmitter 3 of transmission side into the encoded road information (code coordinates and traffic data code) which is digitized data as road information. This demodulation part 19 is equivalent to the demodulation part as described in the claims.

Decoding part 21 decodes the code coordinates and the traffic data code by digital demodulation into the element coordinates and traffic data of original information at the demodulation part 19. In addition, the element coordinates decoded from code coordinates in this decoding part 21 shall be called as decoded coordinates, and decoding of the code coordinates by this decoded coordinates shall be called as decoded coordinates processing. This decoding part 21 is equivalent to the decoded coordinates generation part as described in the claims.

Map coordinates data records department 23 is recording the map coordinates data capable of indicating a position by coordinates. That is, with this map coordinates data, the position of each road is indicated and the position of the road is indicated according to the form of the road by pluralities of map coordinates data (origin [origin node], destination [destination node], interpolation point [a middle point node, usually two or more]). Map coordinates data records department 23 is equivalent to the map coordinates data record part as described in the claims.

The road specification processing part 25 indicates the position of the road based on the decoded coordinates decoded in the decoding part 21 and the map coordinates data recorded in the map coordinates data records department 23. In addition, the processing in this road specification processing part 25 shall be called as road matching processing. The road matching processing (the specific method for a road) in this road specification processing part 25 will be explained hereafter (it will be explained in full detail using FIG. 19 to FIG. 21).

Traffic data-processing part 27 outputs processing information by processing the traffic data decoded at decoding part 21 where the position of the road indicated is associated with. The processing at this traffic data processing part 27 includes a route selection processing which chooses the route (route) used as the shortest time at the time of moving, and a display processing for processing the decoded traffic data for viewing (for displaying). The processing will be described hereafter. (It will be explained in full detail using FIG. 22 to FIG. 31).

Display output part 29 carries out the display output of the processing information outputted in traffic data-processing part 27. In this embodiment, display output part 29 is constituted by a small liquid crystal display and a speaker for voice response.

Operation part 31 carries out the operation of the selection of the processing (route selection processing or display processing) in the traffic data-processing part 27, or enlarging and reducing the display of a surrounding map when the icon showing the moving objects and the destination is displayed in the map around the moving objects in processing information outputted to the display output part 29.

According to this road information receiver 5, modulation signal is received in the receiving part 17, and the code coordinates included in the modulation signal in the demodulation part 19 are collected. The reproduction coordinates for indicating the position of the road based on encoded coordinates and the map coordinates data recorded in the map coordinates data records department 23 in the road specification processing part 25 are generated. In this road information receiver 5, the position of the road is indicated at least using the road information for indicating the position of each road by two element coordinates of origin and destination, without using the VICS link. For this reason, even if the length of a road, the method for connecting the road, the name of the road, and the like are changed, it is not necessary to have a newest database corresponding to the VICS link. That is, the maintenance cost (running cost) of tens of thousands of yen spent in order to purchase a newest database once in two years or three years, is reducible in the road information receiver 5.

Moreover, according to this road information receiver 5, the modulation signal is received at receiving part 17, and the code coordinates and the traffic data code included in the modulation signal is collected at demodulation part 19. Decoded coordinates that decode the code coordinates at decoding part 21 and the traffic data that decodes the traffic data code, are generated. The decoding coordinates for indicating the position of the road in the road specification processing part 25 based on the map coordinates data recorded in the map coordinates data records department 23 and decoded coordinates are generated. Traffic data processing part 27 outputs the processing information in which at least one of the route selection processing or display processing is performed. That is, this road information receiver 5 indicates the position of each road by at least two element coordinates of origin and destination. For this reason, the traffic condition (the shortest route etc.) of the road section with position indicated by the element coordinates can be grasped, without being dependent on the VICS link.

(Operation of Road Information Transmitter)

Next, with reference to a flow chart shown in FIG. 2, operation of road information transmitter 3 will be explained (Preferably see FIG. 1).

First, in traffic data collecting part 7, through a network, the traffic data processed at traffic data-processing part 4 is collected, and is outputted to the encoding part 11 by receiving a broadcast wave (Superimposed on traffic data) (S1).

Then, while the element coordinates recorded in the element coordinates records department 9 are encoded by code coordinates in the encoding part 11, the traffic data inputted from the traffic data collecting part 7 is encoded into the traffic data code. These code coordinates and a traffic data code are associated (collected into one set of a group) and is outputted to modulation part 13 as encoded road information (S2).

And in the modulation part 13, the digital modulation of the encoded road information encoded in the encoding part 11 is applied, to be made into the modulation signal, and outputted to the transmitting part 15 (S3). And in this transmitting part 15, power amplification is applied and the modulation signal is outputted from an antenna towards two or more road information receiver 5 as road information (S4). (as a broadcast wave) (transmission).

(Operation of the Road Information Receiver)

Next, with reference to a flow chart shown in FIG. 3, operation of the road information receiver 5 will be explained (preferably see FIG. 1).

First, the receiving part 17 receives the road information (modulation signal) transmitted from road information transmitter 3 by antenna, detects, and applies power amplification and outputted to the demodulation part 19 (S11). Then, code coordinates and traffic data codes included in the modulation signal in the demodulation part 19 are collected, and outputted to the decoding part 21 (S12).

Then, the code coordinates and the traffic data code which are collected at the demodulation part 19 are decoded in the decoding part 21, that is, the code coordinates are made into decoded coordinates, the traffic data code is decoded to traffic data (decoding corresponding to encoding [decryption] is performed), and outputted to the road specification processing part 25 (S13).

And the decoded coordinates decoded in the decoding part 21 (decoding) and the map coordinates data recorded in the map coordinates data record part 23 are compared by the road specification processing part 25, thus the road specification processing for indicating the position of a road is performed (S14).

Moreover, after the position of a road was indicated by this road specification processing part 25, traffic data processing (route selection processing or display processing) is performed about the traffic data decoded in the decoding part 21 at the traffic data-processing part 27 based on the demand from the user of the road information receiver 5 (operation by the operation part 31), to thereby generate processing information to be outputted to the display output part 29 (S15).

Then, the processing information processed at the traffic data-processing part 27 is displayed on the display output part 29, i.e., the display screen of a liquid crystal display (display means), and outputted from a speaker for voice response (voice response means) (S16).

(About Road Information)

Next, with reference to FIG. 4 to FIG. 9, road information transmitted from road information transmitter 3 will be explained in detail (Preferably see FIG. 1).

FIG. 4 is a view explaining the data structure when element coordinates and traffic data are associated in the encoding part 11 of the road information transmitter 3. As shown in the FIG. 4, the road information consists of a header portion and pluralities of location data portions (n-th portions; from a part I to the n-th portion) and a traffic data portion. The number of bits is allocated to the smallest possible amount of information so that this road information can be efficiently transmitted to a reception side from a transmission side. In addition, each portion from part I to the n-th part corresponds to every one road. That is, the road information shown in this FIG. 4 is intended to include the information (location data and traffic data) about n roads.

A header portion is a portion where every one classified “frame” thereof is described, when the geographical feature on surface of the earth is classified in a secondary mesh (square of about 10000 m×10000 m), wherein [“the total number of data (12 bits)”, “secondary mesh X coordinates (8 bits)” and “secondary mesh Y coordinates (8 bits)”, and] [“order specification (1 bit)”, and “Road classification (2 bits)”, and “direct specification (1 bit)” and “extension bit specification (8 bits)” are included.

“The total number of data (12 bits)” shows the number of bytes of binary data from a part I continuing into the header portion to the n-th portion (the total number of bytes) with 12 bits.

When “secondary mesh X coordinates (8 bits)” classifies the geographical feature on surface of the earth in a secondary mesh, X coordinates per this classified “frame” is shown with 8 bits.

When “secondary mesh Y coordinates (8 bits)” classifies the geographical feature on surface of the earth in a secondary mesh, Y coordinates per this classified “frame” is shown with 8 bits. That is, “secondary mesh X coordinates (8 bits)” and “secondary mesh Y coordinates (8 bits)” show X coordinates and Y coordinates of one “frame” at the time of classifying the geographical feature on surface of the earth in a secondary mesh (to the shape of meshes of a net in every direction) by 16 bits in total.

“Road classification (2 bits)” shows the classification (classification) of the road with 2 bits. The classification of this road is classified into four classification of “high speed between cities”, “metropolitan quantity”, a “general way”, and “others.”

When one road is indicated within one “frame” at the time of “order specification (1 bit)” classifying the geographical feature on surface of the earth in a secondary mesh (to the shape of meshes of a net in every direction), in order to distinguish this indicated road and other roads, the identifier attached (to avoid overlapping) is shown with 1 bit. In addition, in the road information receiver 5 of reception side, this “order specification (1 bit)” is used, in case the position of every one road way is indicated.

“Direct specification (1 bit)” shows the identifier attached with 1 bit in order to specify the element coordinates of the road directly. That is, direct specification shows that the element coordinates (decoded coordinates obtained by encoding and decoding these element coordinates in the road information receiver 5) which indicate the position of the road are specified on the map displayed on the display screen of the display output part 29 of the road information receiver 5 without using the conventional database (database corresponding to the VICS link).

When, “extension bits specification (8 bits)”, “direct specification (1 bit)” is specified, that is, when the position of the road is indicated by element coordinates, specifying the accuracy (changing the number of bits) of coordinates is shown with 8 bits. Specifically these 8 bits (extension bits) is broken into 3 bits allocated to the accuracy of the element coordinates, 1 bit allocated to the accuracy of the angle, 1 bit allocated to the accuracy of distance, and 3 bits secured as remainder.

Here, contents of each bit will be described below. As for the accuracy of the origin coordinate, present condition is maintained when an extension bit is “0” (3-bit binary number, “000”), when the extension bit is “1” to “6” (3-bit binary number, “001” to “110”), it is increased by 1 bit to 6 bit. For example, when the number of quota bits of origin coordinates is 10 bits, the bit number is increased “1” to 11 bits, “4” to 14 bits, and “6” to 16 bits. Moreover, if an extension bit is “7” (the binary number, “111” of 3 bits), when 1-bit reduction, i.e., the number of quota bits of for example, origin coordinates, is 10 bits, the number of bits decreases to 9 bits. As for the accuracy of an angle, and the accuracy of distance, if an extension bit is “0” (the binary number, “0” of 1 bit), present condition is maintained (with no change), and if the extension bit is “1” (1-bit binary number, “1”), it is increased by 1 bit.

Location data portion is a portion where the location data (element coordinates are included) for indicating the position of each road in a “frame” of a secondary mesh is described, and the details of this location data portion is shown in FIG. 5. As shown in FIG. 5, the location data portion includes “A bi-directional flag (1 bit)” and “a travel time flag (1 bit)”, “The coordinates number (5 bits)”, and “X coordinates (10 bits)” and “Y coordinates (10 bits)”, “An angle flag (1 bit)”, “an angle (6 bits or 8 bits)” and “a length flag (1 bit)”, and “length (6 bits or 8 bits)”

“Bi-directional flag (1 bit)” shows the flag that shows the validity of the data included in this location data portion with 1 bit. That is, if this “bi-directional flag (1 bit)” is “0” (the binary number, “0” of 1 bit), it is shown that the data contained in the location data portion is effective. If it is “1” (1-bit binary number, “1”), the invalid data (other data is omitted in fact) contained in the location data portion is shown. When data becomes invalid, the case such that the position of the road is changed etc. is mentioned.

“A travel time flag (1 bit)” shows the flag, which shows the validity of the data included in this location data portion with 1 bit. That is, if this “travel time flag (1 bit)” is “0” (binary number, “0” of 1 bit), it is shown that the data about travel time is contained in location data portion. If it is “1” (1-bit binary number, “1”), it is shown that the data about travel time is not contained in the location data portion.

“The coordinates number (5 bits)” shows the number of the element coordinates included in the location data portion with 5 bits. That is, the element coordinates for 5 bits (32 pieces) can be included in one location data portion at the maximum.

“X Coordinates (10 bits)” shows X coordinates for indicating the position of the road in the “frame” of the secondary mesh with 10 bits.

“Y coordinates (10 bits)” shows Y coordinates for indicating the position of the road in the “frame” of the secondary mesh with 10 bits.

Incidentally, in this embodiment, inside of the “frame” of the secondary mesh is shown by normalized coordinates (X coordinates 0 to about 10000 [1 m interval], Y coordinates 0 to about 10000 [1 m interval]). However, in fact, since X coordinates and Y coordinates can fully indicate the position of the road per 10 m, X coordinates and Y coordinates are shown by the coordinates of 0 to 1000, respectively.

“Angle flag (1 bit)” shows the flag which shows the degree of correction of the angle from origin coordinate which is a first point of indicating the position of a road to the following point (an interpolation point or destination) with 1 bit. That is, if this “angle flag (1 bit)” is “0” (the binary number, “0” of 1 bit), it is shown that correction of an angle is small. If it is “1” (1-bit binary number, “1”), it is shown that correction of an angle is large.

“Angle (6 bits or 8 bits)” shows the correction value of the angle from the origin coordinate (origin), which is a first point of indicating the position of the road, to the following point (an interpolation point or destination) with 6 bits or 8 bits.

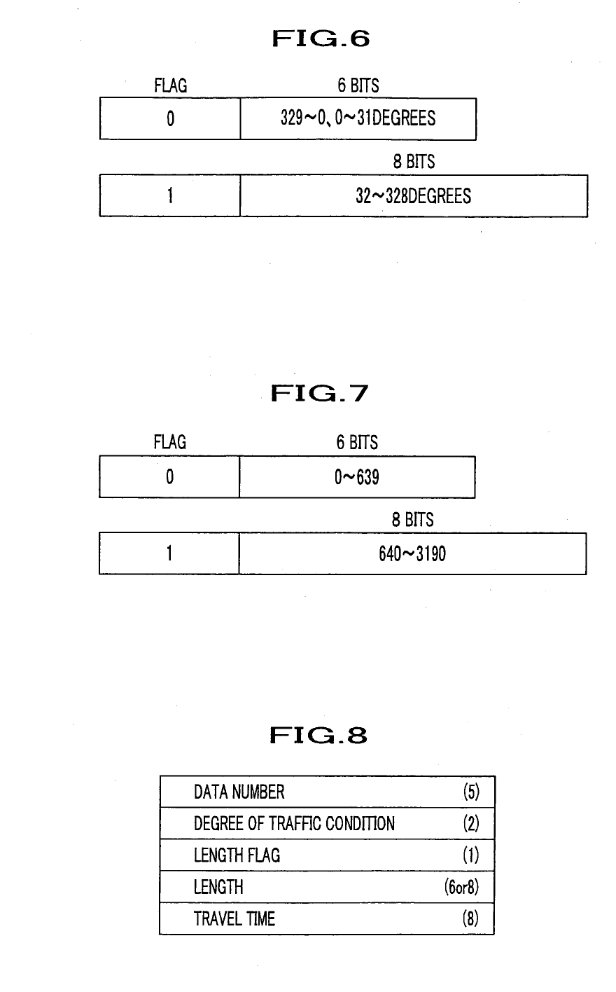

Details of these “angle flag (1 bit)” and “angle (6 bits or 8 bits)” is shown in FIG. 6. As shown in this FIG. 6, “angle (6 bits or 8 bits)” shows the correction value of the angle of 6 bits, i.e., 329 to 0 degrees (149 to 180 degrees), 0 to 31 degrees (180 to 211 degrees) (positive/negative is shown with 1 bit and a number is shown with 5 bits), in this embodiment, when “angle flag (1 bit)” is “0” in this embodiment. When an angle flag (1 bit)” is “1”, “the angle (6 bits or 8 bits)” shows 8 bits, i.e., the correction value of the angle of 32 to 328 degrees (except for 149 to 211 degrees) is shown

“Length flag (1 bit)” shows the flag that shows the degree of distance from origin coordinates (origin) which are the first points of indicating the position of the road to the following point (an interpolation point or destination) with 1 bit. That is, if this “length flag (1 bit)” is “0” (binary number, “0” of 1 bit), it is shown that distance is short. If it is “1” (1-bit binary number, “1”), it is shown that distance is long.

“Length (6 bits or 8 bits)” shows the value (m unit) of the distance from the origin coordinates (origin) which are the first points of indicating the position of the road to the following point (an interpolation point or destination) with 6 bits or 8 bits.

Details of these “length flag (1 bit)” and “length (6 bits or 8 bits)” are shown in FIG. 7. As shown in this FIG. 7, when “a length flag (1 bit)” is “0”, “length (6 bits or 8 bits)” is 6 bits in this embodiment. That is, the value of 0 m to 639 m is shown, and when “a length flag (1 bit)” is “1”, “length (6 bits or 8 bits)” shows the 8 bits, i.e., the value of 640 m to 3190 m.

A traffic data portion is a portion where the traffic data showing the traffic condition of each road is described, and details of this traffic data portion is shown in FIG. 8. As shown in this FIG. 8, the traffic data portion is included with [“data number (5 bits)”], and [“degree of traffic congestion (2 bits)”] a length flag (1 bit)”, and “length (6 bits or 8 bits)” and “travel time (8 bits).

“The data number (5 bits)” shows the number of the element of the traffic data contained in the traffic data portion with 5 bits. That is, the element of the traffic data for 5 bits (32 pieces) can be included in one traffic data portion at the maximum.

“Degree of traffic condition (2 bits)” shows the degree of the traffic congestion in the fixed section of a road with 2 bits. If the degree of the traffic condition is “0” (2-bit binary number, “00”), “unknown.” is shown. If it is “1” (2-bit binary number, “01”), “Degree 1 of traffic condition” of non-congested state is shown. If it is “2” (2-bit binary number, “10”), “Degree 2 of traffic condition” of congested state is shown. And if it is “3” (2-bit binary number, “11”), “Degree 3 of traffic condition” of heavily congested state is shown. The case where 18 seconds or less are taken to pass through a 100 m road in a moving object such as vehicles is defined as “Degree 1 of traffic condition”, and the case where more than 18 seconds and less than 36 seconds are taken is defined as “Degree 2 of traffic condition”, and the case where more than 36 seconds are taken is defined as “Degree 3 of traffic congestion”.

The flag shows the degree of the distance of traffic condition from origin of the traffic condition where the congestion is started, to the destination of the traffic condition where the congestion is gone (Between the points where the degree of the traffic condition is changed), with 1 bit. That is, it is shown that distance is short if this “length flag (1 bit)” is “0” (the binary number, “0” of 1 bit), and if this “length flag (1 bit)” is “1” (1-bit binary number, “1”), it is shown that distance is long.

“Length (6 bits or 8 bits)” shows the value (m unit) of the distance of traffic condition with 6 bits or 8 bits (between the points where the degree of the traffic condition is changed) from the point where the traffic congestion is started to a congestion ending point where traffic congestion is gone.

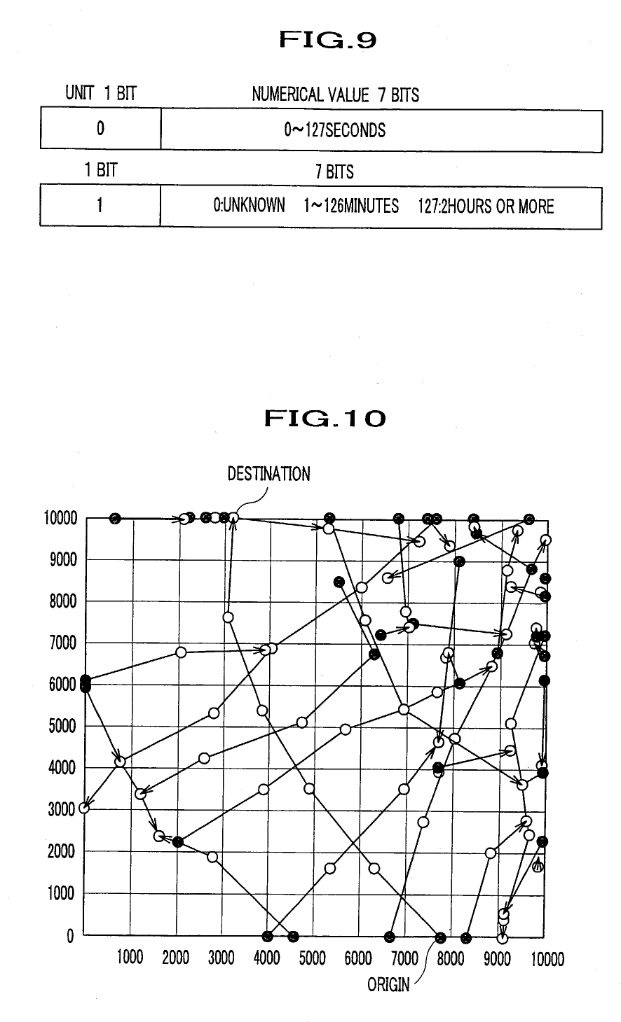

“Travel time (8 bits)” shows the travel time (between the points where the degree of traffic congestion is changed) (move time) from the point where the traffic congestion started to the point where the traffic congestion is gone with 8 bits. Details of the “travel time (8 bits)” are shown in FIG. 9. As shown in this FIG. 9, 1 bit of the head of “travel time (8 bits)” shows the unit of the travel time. In case of “0” (1-bit binary number, “0”), it shows that the time (0 to 127) shown by the subsequent 7 bits is a second bit, and in case of “1” (1-bit binary number, “1”), it shows that the time (0 to 127) shown by the subsequent 7 bits is a minute bit. In addition, when 1 bit of the head of “travel time (8 bits)” is “1”, it shows that “0” is unknown time shown by the subsequent 7 bits, and “1 to 126” means from 1 minute to 126 minutes, and “127” means that it is 2 hours or more.

(Element Coordinates)

Next, with reference to FIG. 10 to FIG. 18, element coordinates will be explained in detail.

The element coordinates recorded in the element coordinates records department 9 of road information transmitter 3 are shown in FIG. 10. In the FIG. 10, the position of the road existing in one “frame” (X coordinates 0 to about 10000, Y coordinates 0 to about 10000) of a secondary mesh is indicated with at least two elements (origin, destination) coordinates. For example, the road where the position is indicated by the “origin” (element coordinates [7800, 0]) and the “destination” (element coordinates [3100, 10000]) shown in the upper part of FIG. 10, is provided with four interpolation points (middle points) in addition to this “origin” and “destination.” (The position (bend condition of a road) of a road is indicated by four interpolation points). In addition, in this FIG. 10, although not shown, the name data where the name of the road is shown is added to the element coordinates.

Also, the correlated use of the element coordinates with traffic data portion has an advantage of not only indicating the position of a road, but indicating arbitrary points, such as a place where traffic accidents happen, and a place for a parking lot, with the point on coordinates.

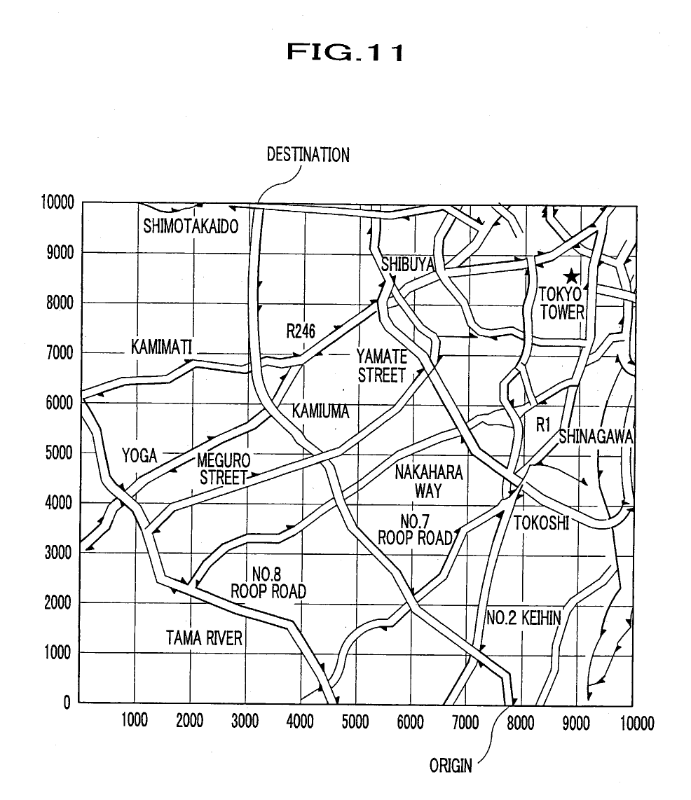

The element coordinates shown in this FIG. 10 are transmitted as road information (modulation signal), received by the road information receiver 5 of a reception side, and displayed on the display screen of the display output part 29. This is shown in FIG. 11. As shown in the FIG. 11, based on element coordinates and name data, “road map” where the position of a road and the name of a road were specified is displayed on the display screen of the display output part 29. With this “road map”, the method (route) of connection of a road becomes clear and the user of the road information receiver 5 can grasp the route from the present position (star mark near “Tokyo Tower” which is upper part of the right-hand-side in FIG. 11) to the destination (for example, Yoga in the middle of left-hand side in FIG. 11)).

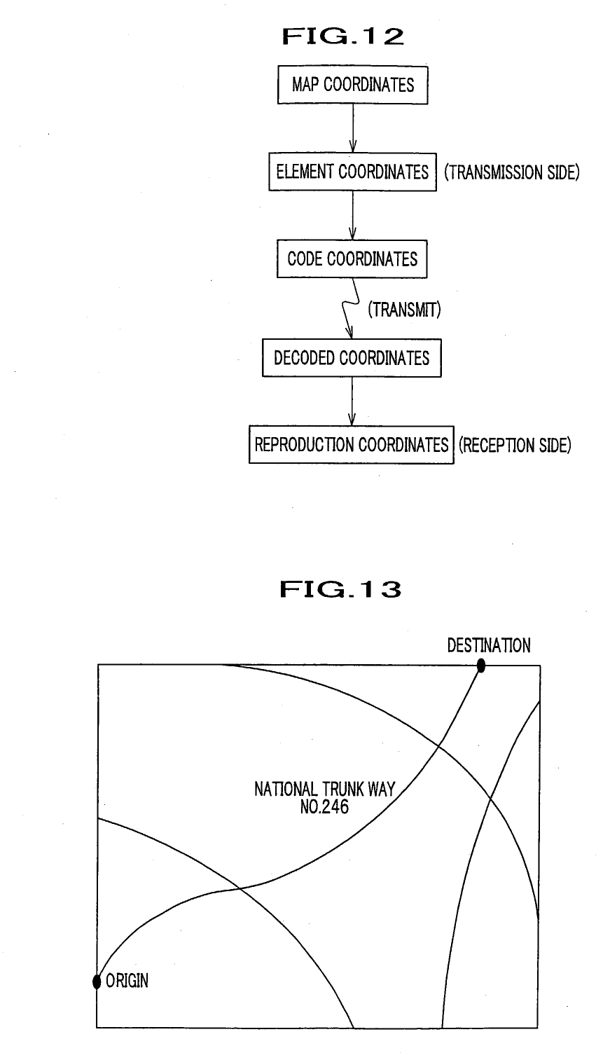

Here, changes of name of the element coordinates explained in the constitution of the road information transmitter 3 and the road information receiver 5 are shown in FIG. 12. In the road information transmitter 3 of a transmission side as shown in the FIG. 12, map coordinates are transmitted to element coordinates, these element coordinates are transmitted to code coordinates, and these code coordinates are transmitted with the name changed in such a way that code coordinates is changed into decoded coordinates, and the decoded coordinates is changed into reproduction coordinates. That is, the map coordinates included in map coordinates data are extracted, and the element coordinates are generated (explanation thereof will be given in detail below in conjunction with FIG. 13 to FIG. 18.). And these element coordinates are recorded in the element coordinates records department 9 of the road information transmitter 3. The element coordinates are coded by code coordinates in the encoding part 11 of the road information transmitter 3. Moreover, code coordinates are decoded into decoded coordinates in decoding part 21 of the road information receiver 5. And based on the decoded coordinates and the map coordinates data recorded in the map coordinates data records department 23, reproduction coordinates are generated in the road specification processing part 25.

Next, a creation process of the element coordinates from the map coordinates, and the correction process of the element coordinates for correcting the created element coordinates will be explained with reference to FIG. 13 to FIG. 18.

It is assumed that element coordinates indicate incorrectly another road (for example, parallel road) near the road the position of which is indicated, due to accuracy difference and a different number of digits (it changes according to the number of bits to be used), or due to a little bit of difference of the map coordinates data recorded in the map coordinates data records department 23 of the road information receiver 5 of the reception side. In order to prevent this misjudge, a middle point node (interpolation point), i.e., middle element coordinates, is needed.

Wherein, as for the road information transmitted from the road information transmitter 3 of the transmitting side to the road information receiver 5 of the receiving side (element coordinates are included as code coordinates), it is required that the position of the road can be indicated correctly, and the amount of information transmitted can be controlled as much as possible (the efficiency of encoding is good on transmitting). For this reason, (1) To set up of the number of the element coordinates for indicating the position of a road correctly, and the value (correction is included) of the element coordinates. (2) On transmitting, the algorithm of the creation process of element coordinates is set up based on raising the efficiency of encoding (lessening the number of encoding bits). Hereupon, the minimum required element coordinates are two points, that is, origin and destination. And in order to indicate a more correct position of a road, a middle point node (interpolation point) is inserted. The element coordinates of the origin is shown by X coordinates and Y coordinates, shown by 0 to 1000 with 10 bits respectively, and the position of the road shall be shown by an angle difference and distance from the element coordinates of this origin (the maximum value capable of showing the distance is 3190 m).

An outline of “National trunk way No.246” is shown in FIG. 13 as an example of the road included in the map coordinates data. The FIG. 13 shows one “frame” at the time of classifying a surface-of-the-earth in a secondary mesh. As shown in the FIG. 13, the position on surface of the earth is indicated by origin (origin node) and destination (destination node). Moreover, other curves shown in the FIG. 13 show that another road exists (there will be three another roads). Although not shown in the FIG. 13, map coordinates are given to the origin (the origin node) and the destination (the destination node),

In addition, in order to show the position of a road more correctly, as many element coordinates as possible are required (it can be referred to as point row of the element coordinates). Wherein, when there are only three roads except for “National trunk way No.246” (the number of roads of this level) as shown in FIG. 13, the position of “National trunk way No.246” can be indicated only by the origin (the origin node) and the destination (the destination node). However the road is finely complex in many cases. Therefore, generally in order to indicate the position of the road, the optimal middle point node (interpolation point) is required.

Moreover, when the same map coordinates data is adopted at road information transmitter 3 of the transmission side, and the road information receiver 5 of the reception side, (When the map coordinates data of a transmission side used in case element coordinates are created, and the map coordinates data of the map coordinates data records department 23 provided at a receiving side is the same), the position of a road can be indicated comparatively smoothly. However, when the map coordinates data of the map coordinates data records department 23 provided in the road information receiver 5 of the reception side differs (when there are various kinds), there is a possibility that it may become difficult to indicate the position of the road. That is, the position of a road may be specified incorrectly. In order to prevent incorrect specification of the position of the road, the processing of shifting the element coordinates intentionally in the opposite direction to the road with a possibility of being specified by mistake, is performed after creating element coordinates, in the correction process of the element coordinates.

[A Creation Process of Element Coordinates]

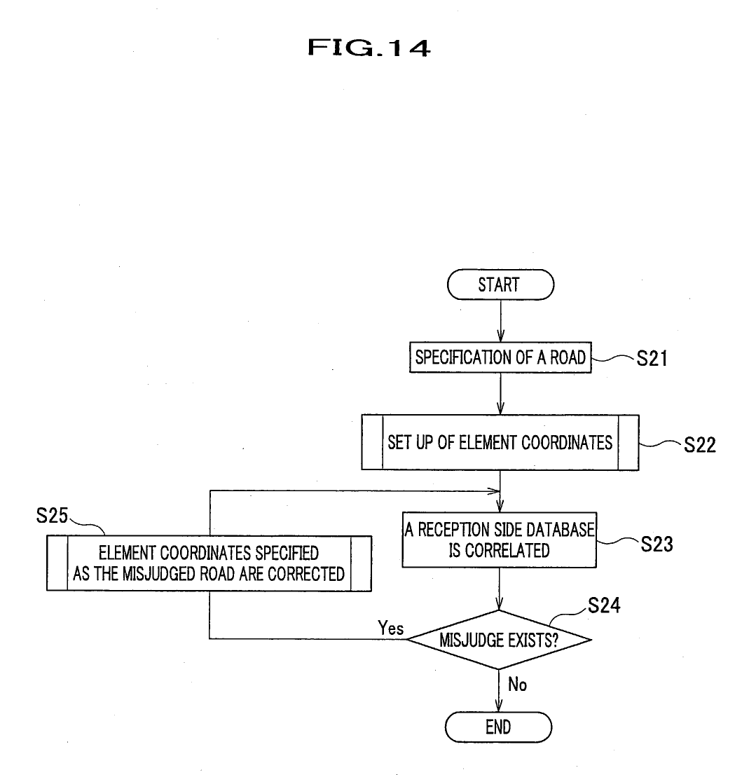

A procedure of the creation process of element coordinates that creates element coordinates from the map coordinates of the “National trunk way No.246” will be explained with reference to the flow chart shown in FIG. 14.

First, a road, which creates element coordinates is specified (S21). In this case, “National trunk way No.246” will be specified. Subsequently, a setup of the element coordinates is performed (S22). In this case, origin (origin node) and destination (destination node) of “National trunk way No.246” are set up. And it is compared with the reception side database (equivalent to the map coordinates data records department 23) provided in the road information receiver 5 of the reception side. (S23). It is judged whether there is misjudge, that is, it is judged whether the position of “National trunk way No.246” is correctly reproducible at the reception side. When judged that there is no misjudgment (reproduction is possible) (S24, No), creation of the element coordinates is ended. When judged that there is misjudge (reproduction is impossible) (S24, Yes), the element coordinates indicated as the misjudged road are corrected (S25). Or correction is performed so that a middle point node (interpolation point) may be set up at a suitable interval and the exact position of “National trunk way No.246” can be indicated between the origin (the origin node) and the destination (the destination node).

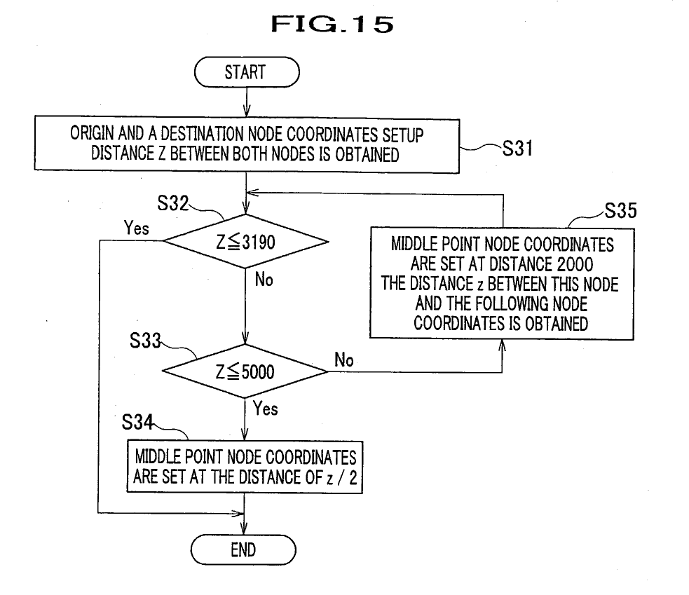

The method for a setup of the middle point node (the interpolation point) will be explained with reference to a flow chart shown in FIG. 15.

First, the coordinates of the origin (the origin node) and the destination (the destination node) are set up. Therefore, distance Z between both nodes is computed from the coordinates of the origin (the origin node) and the destination (the destination node) (S31). Subsequently, it is judged whether this distance Z is 3190 m or less (S32). When judged that it is 3190 m or less (S32, Yes), a middle point node is not set up. When judged that it is not 3190 m or less (S32, No), it is judged whether Distance Z is 5000 m or less (S33). When judged that Distance Z is 5000 m or less (S33, Yes), a middle point node (an interpolation point) is set at the place of distance Z/2 (exactly middle of the distance Z) (S34). (The corresponding element coordinates are chosen). Moreover, when not judged that Distance Z is 5000 m or less in S33 (S33, No), the middle point node (The interpolation point) is set in the distance of 2000 m (the corresponding element coordinates is chosen) and the distance z between the coordinates of this middle point node (the interpolation point) and the following node (the destination node) is computed (S35), to return to S32.

That is, as explained with reference to a flow chart shown in this FIG. 15, the middle point node (the interpolation point) is created, when the interval of the origin (the origin node) and the destination (the destination node) is 3190 m or more (the corresponding element coordinates are chosen).

[Correction Process of Element Coordinates]

Next, a correction process of the element coordinates when the position of a road cannot be specified correctly due to the element coordinates created at the creation process of the element coordinates, will be explained. First, it is confirmed whether the position of the road can be specified correctly in the road specification processing part 5 of the road information receiver 5 of the reception side. In the reception side, reproduction coordinates are generated based on the element coordinates included in the received road information and the map coordinates data recorded in the map coordinates data records department 23, and the map coordinates data which suits the element coordinates most shall be reproduction coordinates. In this case, when the position of the road is indicated by pluralities of element coordinates, if the angle from some element coordinates to the following element coordinates formed successively is not taken into consideration, the road of the opposite direction may be indicated. Therefore, the direction of the straight line connecting element coordinates is shown with the angle of 360 degrees, and the difference of the angle of the connecting straight line shall be less than ±45 degrees. The element coordinates of the shortest distance are chosen as the basis of this condition (difference of the angle of the connecting straight line is less than ±45 degrees). And by the pluralities of these element coordinates, the position of a road is indicated.

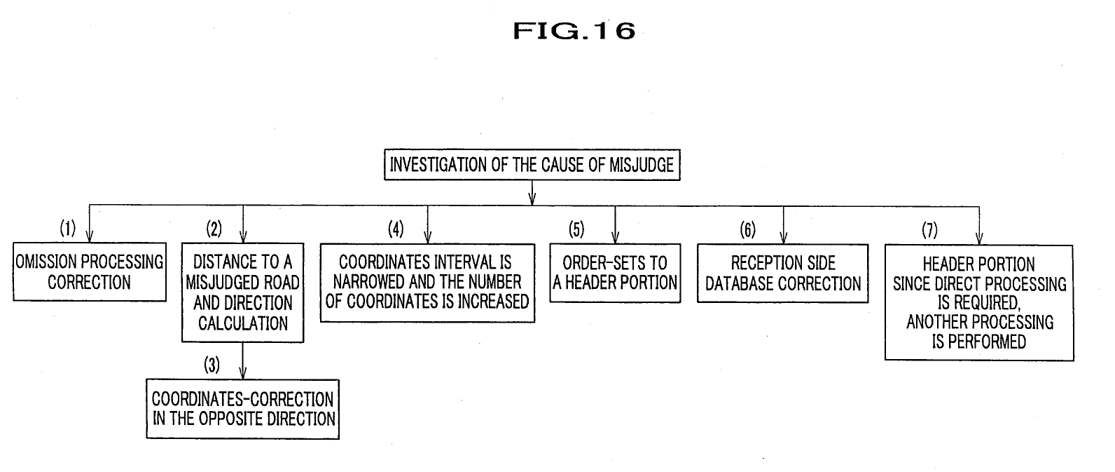

Here, when element coordinates must be corrected, that is, the cause of an misjudgement and management of the element coordinates in case the position of a road is incorrectly set and indicated in a reception side, will be explained with reference to FIG. 16. As shown in the FIG. 16, the cause of an error and management of the element coordinates are mentioned as follows: (1) Correction by rounding processing, (2) Misjudged distance of a road and misjudged direction calculation, (3) Coordinates correction in the opposite direction, (4) the coordinates interval is narrowed and the number of coordinates is increased, (5) Order-sets to a header portion, (6) Reception side database correction, (7) Another processing in a header portion, since direct processing is required.

(1) Correction by rounding processing. When encoded in encoding part 11 of road information transmitter 3, the position of the misjudged road is indicated in the road information receiver 5 of the reception side, due to the rounding of the number of digits of the element coordinates. In such a case, up valuation of a numerical value is performed.

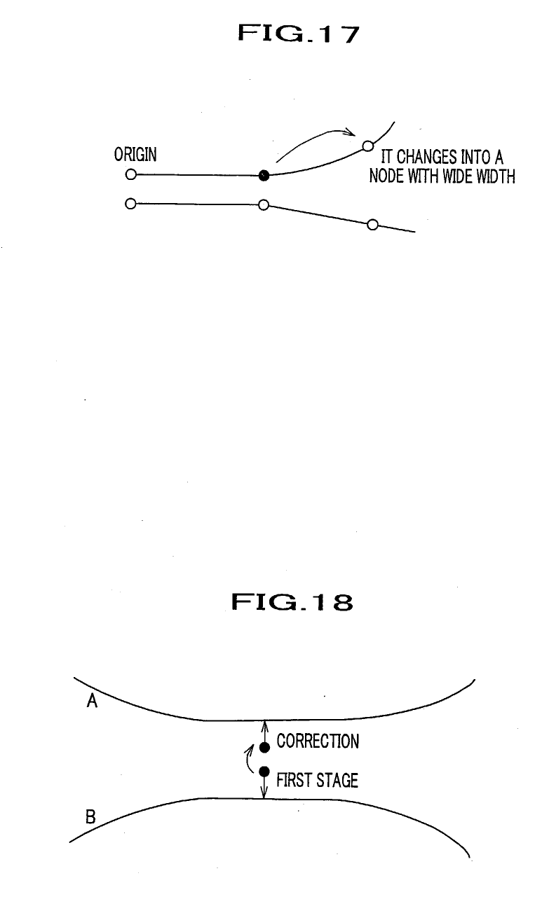

(2) Misjudged distance of a road and misjudged direction calculation. For example, as shown in FIG. 17, when the position of a road is indicated by origin (origin node) and a middle point node (a black point in FIG. 16), in a middle point node, there is a possibility of indicating adjoining another road incorrectly. Therefore, it is changed into the middle point node in the direction (opposite direction) where difference of the angle of the straight line connecting the middle point node from the origin, and another adjoining road (straight line connecting the element coordinates) is generated (changed into a node with wide width).

(3) Coordinates correction in the opposite direction. For example, as shown in FIG. 18, two roads A and B are close in map coordinates data recorded in the map coordinates data records department 23. When element coordinates (initial element coordinates) exist in the middle of the section where these roads A and B run in parallel (these element coordinates indicate the position of road A), the initial element coordinates are corrected in the normal direction so that road A can be chosen in the road information receiver 5 of reception side.

(4) The coordinates interval is narrowed and the number of coordinates is increased. Since the position of a road is indicated, the interval (distance) of the element coordinates formed successively is shortened to 2000 m or less, and the number of element coordinates is increased. In addition, when the number of element coordinates is increased, the element coordinates with a possibility of misjudging the position of a road can be avoided.

(5) An order setup to a header portion. “Order specification (1 bit)” included in the header portion is set up as it is effective. That is, the element coordinates of the road where the position was indicated, and the element coordinates of the road where the position is not indicated are distinguished, the element coordinates of the road where the position is indicated are excluded to indicate the position of a road.

(6) Reception side database correction. Map coordinates data recorded in the map coordinates data records department 23 of the road information receiver 5 of reception side is corrected. That is, it is necessary to distribute the map coordinates data corresponding to the element coordinates recorded in the element coordinates records department 9 of the road information transmitter 3 of transmission side. Wherein, the method for this management is not performed as much as possible.

(7) In a header portion, since direct processing is required, another processing is performed. The system that specifies direct coordinates is adopted about the road which cannot indicate a position by the road information receiver 5 of reception side. In addition, the method for this management is final (when it cannot be managed by (1) to (6)).

(Method for Indicating a Road)

Next, with reference to FIG. 19 to FIG. 21, road matching processing (how to indicate the position of a road) in road specification processing part 25 of the road information receiver 5 will be explained in detail.

In the road information receiver 5, the position of a road is indicated in the road specification processing part 25 based on the road information (element coordinates are included) transmitted from the road information transmitter 3 of transmission side, and map coordinates data recorded in the map coordinates data records department 23. In this road specification processing part 25, as shown in FIG. 19, the position of a road is indicated by adopting matching with decoded coordinates (element coordinates, black point in FIG. 19), and the road drawn by the map coordinates data recorded in the map coordinates data records department 23. (Coordinates included in map coordinates data are connected. Curved line in FIG. 19.). In this matching, two or more roads drawn by map coordinates data are subdivided first, and every line of these roads shall be collected in linear set. (When the curved road is subdivided, it can be taken as a linear set). Subsequently, as for each road, the straight line (the shortest distance straight line) in the shortest distance is chosen from each decoded coordinates (origin and an interpolation point [usually two or more], and destination) in the normal direction of each subdivided straight line. And it is regarded that the road drawn by map coordinates data having these shortest distance straight lines most is indicated by element coordinates.

Moreover, as shown in FIG. 19, if the position of a road is indicated only by being located near the road where decoded coordinates are drawn by map coordinates data, there is a possibility of choosing the road of the opposite direction (the arrow from a black point is □misjudge□in FIG. 19). In order to prevent such misjudge, the road drawn by the map coordinates data which runs along with (it is in agreement with) the direction of the straight line (decoded coordinates sequence approximation straight line) approximated by sequence (decoded coordinates point row) of decoded coordinates is chosen (the arrow from the black point is [correction] in FIG. 19).

Here, in the road information receiver 5, the processing (mainly road matching processing of the road specification processing part 25) that indicates the position of a road will be explained with reference to the flow chart shown in FIG. 20 (preferably see FIG. 1).

First, decoded coordinates are collected from code coordinates by decoded coordinates processing in the decoding part 21 of the road information receiver 5 (S41). And road matching processing is performed in the road specification processing part 25 (S42). Here, it is judged first whether the decoded coordinates decoded in the decoding part 21 are wholly included in a road drawn by map coordinates data (S43). (Whether the selected node [Decoded coordinates] is the same road altogether). When it is judged that the decoded coordinates are wholly included in the road drawn by map coordinates data (whether the road is the same altogether) (S43, Yes), the position of a road is indicated on the road (road of the selected node sequence) drawn by map coordinates data (S44) (determination).

Moreover, when it is judged that the decoded coordinates are not included in the road drawn by map coordinates data (whether the road is the same altogether) in S43 (S43, No), it is judged whether there is any road (road containing most nodes) drawn by the map coordinates data including decoded coordinates most (S45). When judged that there is a road (road containing nodes most) drawn by the map coordinates data including most decoded coordinates (S45, Yes), the position of the road is indicated on the road (road containing most nodes) drawn by the map coordinates data including decoded coordinates most (S46). (determination). When not judged that there is a road (road containing nodes most) drawn by the map coordinates data including decoded coordinates most in S45 (S45, No), that is, when the number of the decoded coordinates included in the road drawn by map coordinates data is the same, or when there are no decoded coordinates included in the road drawn by map coordinates data, it is supposed that road specification is impossible (S47).

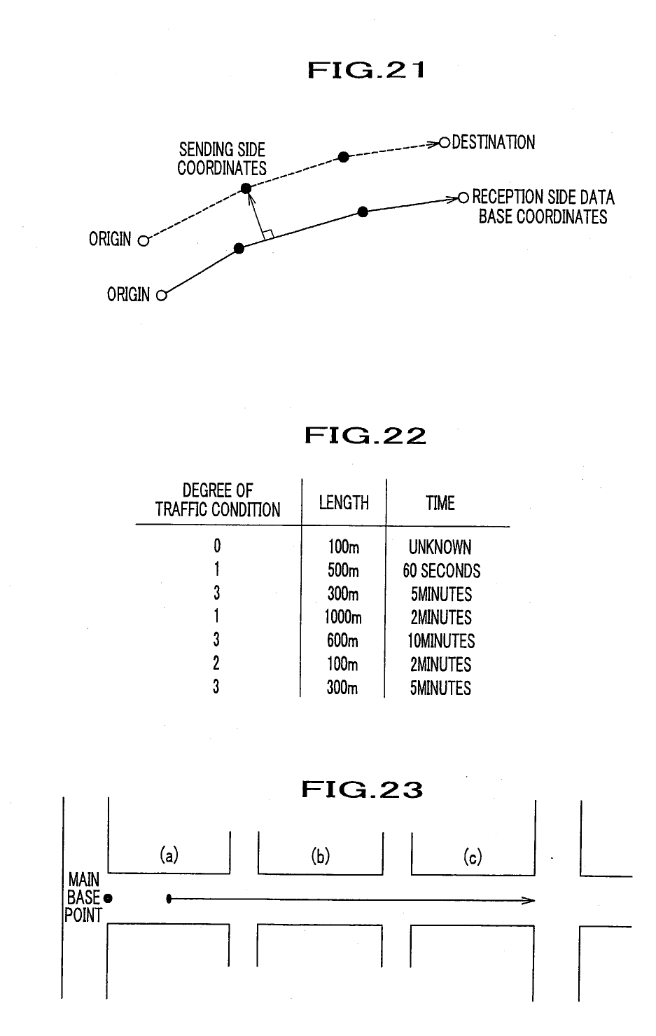

Furthermore, road matching processing of the road specification processing part 25 when the distance from the road drawn by the map coordinates data recorded in the map coordinates data records department 23 of the road information receiver 5 of reception side to decoded coordinates is long (when decoded coordinates are not included in a road drawn by map coordinates data) will be explained with reference to FIG. 21 here.

FIG. 21 shows the road (sending side coordinates in FIG. 21) drawn by decoded coordinates (element coordinates), and the road (reception side database coordinates in FIG. 21) drawn by the map coordinates data recorded in the map coordinates data records department 23.

When distance from the road drawn by map coordinates data to decoded coordinates is long, it becomes difficult to indicate the map coordinates data corresponding to decoded coordinates (to choose reproduction coordinates). However, when the distance from the road drawn by map coordinates data to decoded coordinates is long, the shortest distance may exist between the straight lines which connected decoded coordinates and map coordinates data. Therefore, in road matching processing of the road specification processing part 25, as shown in the FIG. 21, normal line is lengthened on decoded coordinates from the straight line connecting map coordinates data. And based on the length of this normal line, the straight line connecting the map coordinates data corresponding to decoded coordinates is chosen. And the map coordinates data positioned nearest to the decoded coordinates in the straight line connecting the selected map coordinates data is selected as reproduction coordinates.

(Processing of Traffic Data)

Next, processing of traffic data will be explained with reference to FIG. 22 to FIG. 31.

The traffic data (mainly traffic congestion information [traffic congestion data]) contained in the road information transmitted from road information transmitter 3 is formed so as to be shown by Degree of traffic condition, length, and time from the origin of a road. This system excels in transmission efficiency to road information receiver 5 of the reception side from road information transmitter 3 of the transmitting side, and it does not correspond to the section (divided for every main crossings), obtained by dividing the road finely like the conventional VICS link.

Hereupon, in traffic data-processing part 27 of the road information receiver 5, the section to need traffic congestion information (traffic congestion data) is specified, and processing for computing the degree of traffic congestion of this section and the time (time required) to pass, is performed. The time required of the desired section can be obtained by this process. That is, the minimum unit which divides the road where the position is indicated in the road specification processing part 25 into the fine section is the straight line (between one node and the nodes of another side) connecting reproduction coordinates. Therefore, the degree of traffic condition and the time required of this straight line are computed by the traffic data-processing part 27.

Incidentally, in the receiver equipped with the VICS link database corresponding to the conventional VICS link for moving object loaded therein (not shown), the degree of traffic condition and the time required (link travel time) are computed for every VICS link, the VICS link corresponds to the coordinates on a map (it can be called a node), and the coordinates on two or more maps correspond to one VICS link. In addition, generally the length of the VICS link is longer than the length of the section connected by two coordinates.

Here, an example of traffic congestion information of the traffic data contained in the road information transmitted from road information transmitter 3 (traffic congestion data) is mainly shown in FIG. 22. As shown in the FIG. 22, the degree of traffic condition from the origin of a road is changing with 0, 1, 3, 1, 3, 2, and 3, the length (distance) corresponding to these levels of the traffic condition is 100 m, 500 m, 300 m, 1000 m, 600 m, 100 m, and 300 m, and the time to move these length (distance) is unknown, 60 seconds, 5 minutes, 2 minutes, 10 minutes, 2 minutes, and 5 minutes. Traffic congestion information (traffic congestion data) shown in the FIG. 22 is shown sequentially from the origin (it can be called as origin of reproduction coordinates, and a main base point) of a road, in this example, and the move time of the 100 m section is unknown from the main base point. It is shown that the move time of the 500 m section is 60 seconds from there (it can be said that there is no traffic congestion), and the move time of the 300 m section is 5 minutes from there further (it can be said that there is traffic congestion).

Next, the processing (desired section traffic congestion data division processing) to divide traffic congestion information (traffic congestion data) into the desired section (unit) in the traffic data-processing part 27 of the road information receiver 5 will be explained with reference to FIG. 23.

In the traffic data-processing part 27 of the road information receiver 5 of reception side, the optimal route (the route where the time required becomes the minimum, section of a road) is calculated, and route selection processing which chooses this route, and display processing which calculates a unit required to display this route so as to be displayed on the display screen of the display output part 29 are performed. In such case, the processing which divides traffic congestion information (traffic congestion data) is needed for the desired section (unit) first. As explained using FIG. 22, on the basis of the level of traffic condition, length (distance) and time are added and traffic congestion information (traffic congestion data) is created. Therefore, it is necessary to allocate this traffic congestion information (traffic congestion data) for every unit, which can be divided (every reproduction coordinates) of a road.

FIG. 23 schematically shows a road (road which extends horizontally in FIG. 23 [shown by arrow]) where the level of traffic condition differs in each section, and pluralities of roads that intersect this road. Also, in the FIG. 23, “a main base point” shows origin (origin of reproduction coordinates) of a road, and (a), (b), and (c) show the section divided according to the level of traffic condition.

The section (a) is 600 m, the section (b) is 300 m, and the section (c) is 400 m. When the traffic congestion (congestion data) is described in such a way that move time from the main base point covering the length (distance) 350 m is 60 seconds (the degree 1 of traffic congestion), and the move time from a length (distance) of 351 m from the main base point covering the length (distance) of 100 m is 10 minutes, the time required of each section (a), (b), and (c) is as follows.

The time required of the section (a) becomes 60-second+(600−350)m/1000×10-minute×60-second=60-second+150-second→3 minutes and 30 seconds.□ The time required of the section (b) becomes 300 m/1000 m×10-minute×60-second=180-second→3 minutes. The time required of the section (c) becomes 400 m/1000 m×10-minute×60-second=240-second→4 minutes.

As described above, in the road where the levels of traffic condition differ, the time required of each section is computable in each section. In addition, if the same processing is performed to a reception side also when the conventional VICS link has been transmitted from the transmission side, in a road where the levels of traffic condition differ, the time required of each section is computable in each section.

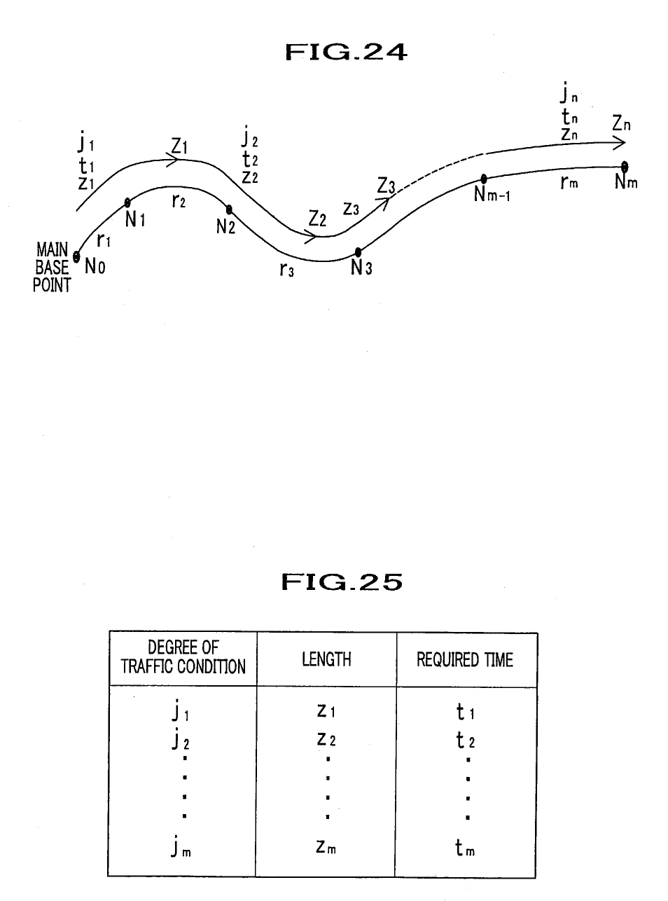

Next, how to show general traffic congestion information (traffic congestion data) will be explained with reference to FIG. 24.

FIG. 24 shows a comparative view of the road where position is indicated, and the congestion information of this road (congestion data).

The road is shown by the reproduction coordinates (node) N₀-Nₘ and the distance r₁-rₘ between reproduction coordinates (node) as shown in this FIG. 24. Traffic congestion information (traffic congestion data) is shown by cumulative traffic congestion distance Z1-Zn from the main base point for every change of the level of the traffic condition, the degree of traffic condition is shown by j₁-jₙ, the length of the congestion (congestion length) is shown by z₁-zₙ, and required time is shown by t1-tn. That is in this FIG. 24, for example it is shown that the length from the main base point to the cumulative congestion distance Z1 to Z2 is z₁, traffic condition degree of this section is j₁, and the time required is t₁. Similarly the length of the cumulative congestion distance Z1 to Z2 is z2, the degree of traffic condition of this section is j₂, and the time required is t₂.

Moreover, the cumulative traffic congestion distance Zn can be obtained by the following formula 1. Moreover, the cumulative time required Tₙ can be obtained by the following formula 2.

$$\begin{matrix}{Z}_{n} = {\sum }_{k = 1}^{n} {z}_{k} & ( 1 ) \\ {T}_{n} = {\sum }_{k = 1}^{n} {t}_{k} & ( 2 )\end{matrix}$$

Furthermore, a road is divided by reproduction coordinates (node) N₀ to Nₘ. Since distance between reproduction coordinates (node) is r₁ to rₘ, cumulative distance Rₘ from a main base point to reproduction coordinates can be obtained by the following formula 3. Furthermore, x and y coordinates is possible between reproduction coordinates (node). Then when it is shown in N₀ (x₀, y₀) and N₁ (x₁, y₁) . . . Nₘ (xₘ, yₘ), the distance rₘ between reproduction coordinates (node) can be obtained by the following formula 4.

$${R}_{m} = {\sum }_{k = 1}^{m} {r}_{k} \qquad ( 3 )$$

rₘ=\sqrt{(Xₘ−Xₘ₋₁)²+(Yₘ−Yₘ₋₁)²} (4)

Next, how to obtain the traffic congestion information (traffic congestion data) between reproduction coordinates (node) will be explained with reference to FIG. 25 to FIG. 28.

FIG. 25 is a view showing the traffic congestion information (congestion data), that is, showing collectively j₁-jₘ of traffic congestion included in the traffic data transmitted from road information transmitter 3 (traffic congestion data), i.e., the degree of traffic condition is shown by j₁-jₘ, the length is shown by z₁-zₘ, and the time required is shown by t₁-tₘ in the table.

In the following three cases of (1) to (3), how to obtain the degree of traffic condition jᵢ of the link Lᵢ, the length of the congestion zᵢ, and the time required tᵢ when setting links L₁-Li between two reproduction coordinates (nodes), in case of □_{□}□□_{□} to □_{□}□□_{□}□□_{□□□} to □_{□} respectively, will be explained. These three cases are as follows: (1) The case of one traffic congestion information (congestion data) concerning the link Li, (2) The case of two traffic congestion information (congestion data) concerning the link Li, (3) The case of three or more traffic congestion information (congestion data) concerning the link Li. In addition, it will be explained based on the condition that the link Li is mainly correlated with the degree of traffic condition jₘ, the length zₘ, and the time required tₘ serving as the m-th congestion information (congestion data).

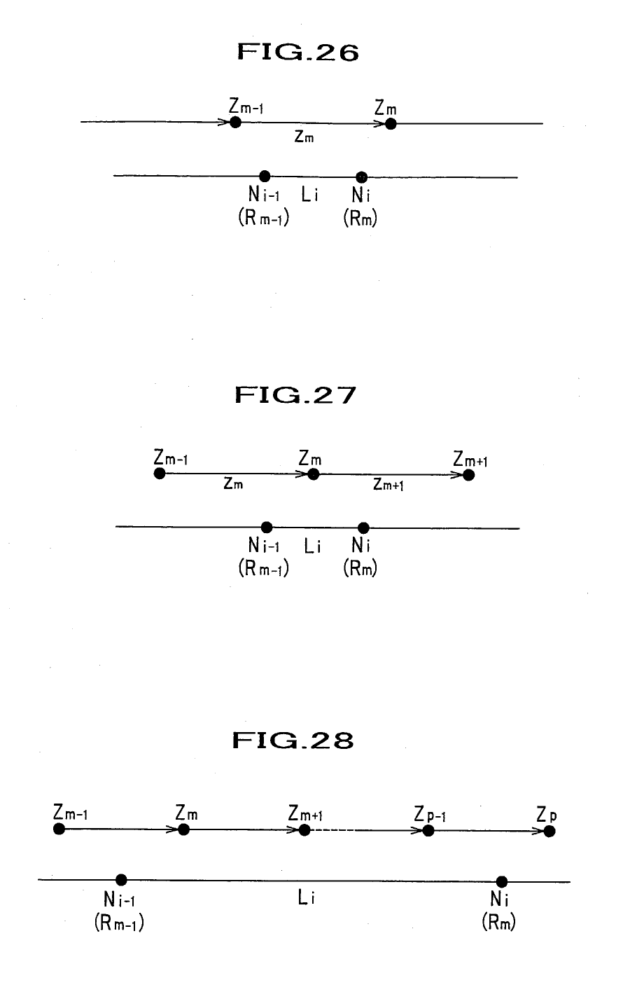

(1) Explanation will be given about the case where traffic congestion information (congestion data) concerning the link Li is one, with reference to FIG. 26. Links Li are the reproduction coordinates Nᵢ₋₁ (Rₘ₋₁) to reproduction coordinates Nᵢ (Rₘ), and the length of Link Li is rᵢ (not shown). And the traffic congestion information (traffic congestion data) correlated with this is only traffic condition degree jₘ of the cumulative traffic congestion distance Zₘ₋₁ to cumulative traffic congestion distance Zₘ, length zₘ, and the time required tₘ. In this case, the link Li is included in the cumulative congestion distance Zₘ₋₁ to cumulative congestion distance Zₘ, the degree jᵢ of traffic congestion of Link Li is the same as the degree jₘ of traffic condition, the length zᵢ of traffic congestion is the same as the length rᵢ (not shown) of the Link Li, and the time required tᵢ becomes length rᵢ/length zₘ×time required tₘ of the Link Li. (2) Explanation will be given about the case where the number of the traffic congestion information (traffic congestion data) correlated with Link Li is two, with reference to FIG. 27. Links Li are the reproduction coordinates Nᵢ₋₁ (Rₘ₋₁) to reproduction coordinates Nᵢ (Rₘ), and the length of the Link Li is rᵢ (not shown). The traffic congestion information (traffic congestion data) correlated with this is the congestion degree jₘ of the cumulative traffic congestion distance Zₘ₋₁ to cumulative traffic congestion distance Zₘ, length zₘ, the time required tₘ, congestion degree jₘ₊₁ of cumulative traffic congestion distance Zₘ to cumulative traffic congestion distance Zₘ₊₁, length zₘ₊₁, and time required tₘ₊₁. In this case, traffic condition degree jᵢ of Link Li becomes traffic condition degree jₘ in the section of cumulative traffic congestion distance Zₘ to cumulative distance Rₘ₋₁, and in the section of the cumulative distance Rₘ to cumulative traffic congestion distance Zₘ, it becomes traffic condition degree jₘ₊ᵢ. Moreover, the length zᵢ of traffic congestion is the same as the length rᵢ (not shown) of Link Lᵢ, the time required tᵢ becomes (cumulative traffic congestion distance Zₘ to cumulative distance Rₘ₋₁)/zₘ×time required tₘ+(cumulative distance Rₘ to cumulative traffic congestion distance Zₘ)/zm+1×time required tₘ₊₁.

(3) The case where the traffic congestion information (traffic congestion data) correlated with Link Li is three or more will be explained with reference to FIG. 28. Links Li are the reproduction coordinates Nᵢ₋₁ (Rₘ₋₁) to reproduction coordinates Nᵢ (Rₘ), and the length of Link Lᵢ is rᵢ (not shown). Traffic congestion information (traffic congestion data) correlated with this is cumulative traffic congestion distance Zₘ₋₁ to traffic congestion degree jₘ of the cumulative traffic congestion distance Zₘ, length zₘ, the time required tₘ, traffic condition degree jₘ₊₁ of cumulative traffic congestion distance Zₘ to cumulative traffic congestion distance Zₘ₊₁, length zₘ₊₁, time required tₘ₊₁, and . . . traffic condition degree jₚ of the cumulative traffic congestion distance Zₚ₋₁ to cumulative traffic congestion distance Zₚ, length zₚ, and the time required tₚ. In this case, traffic condition degree jᵢ of Link Li becomes traffic condition degree jₘ in the section of cumulative traffic congestion distance Zₘ to cumulative distance Rₘ₋₁, and in section of the cumulative congestion distance Z_{P-1} to cumulative congestion distance Zₘ, traffic condition degree changes from jₘ₊₁ to jₚ₋₁, and in the section of cumulative distance Rₘ to cumulative distance Zₚ₋₁, the traffic condition degree becomes jₚ. Moreover, length zᵢ of traffic condition is the same as length rᵢ (not shown) of Link Lᵢ, the time required tᵢ becomes (cumulative traffic congestion distance Zₘ to cumulative distance Rₘ₋₁)/zₘ×sum total time from time required tₘ₊₁ to the time required tₚ₋₁+(cumulative distance Rₘ to cumulative traffic congestion distance Zₚ₋₁)/zₚ×time required tₚ.

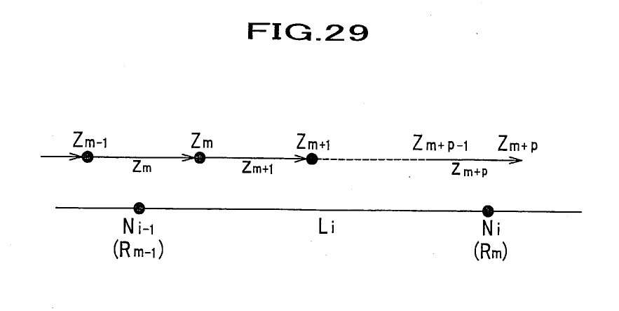

Next, how to obtain the time required between reproduction coordinates (node) from traffic congestion information (traffic congestion data) will be explained with reference to FIG. 29 to FIG. 31.

Between [Li] reproduction coordinates (node) for obtaining the time required, that is, link Li and traffic congestion information (traffic congestion data) correlated with this link Li are shown in FIG. 29. The traffic congestion information (traffic congestion data) correlated with this link Li is traffic condition degree jₘ of cumulative traffic congestion distance Zₘ₋₁ to cumulative traffic congestion distance Zₘ, length zₘ, time required tₘ, the traffic condition degree jₘ₊₁ of cumulative traffic congestion distance Zₘ to cumulative traffic congestion distance Zₘ₊₁, length zₘ₊₁, time required tₘ₊₁, . . . and traffic condition degree jₘ₊ₚ of cumulative traffic congestion distance Zₘ₊ₚ₋₁ to cumulative traffic congestion distance Zₘ₊ₚ, length zₘ₊ₚ, time required tₘ₊ₚ.

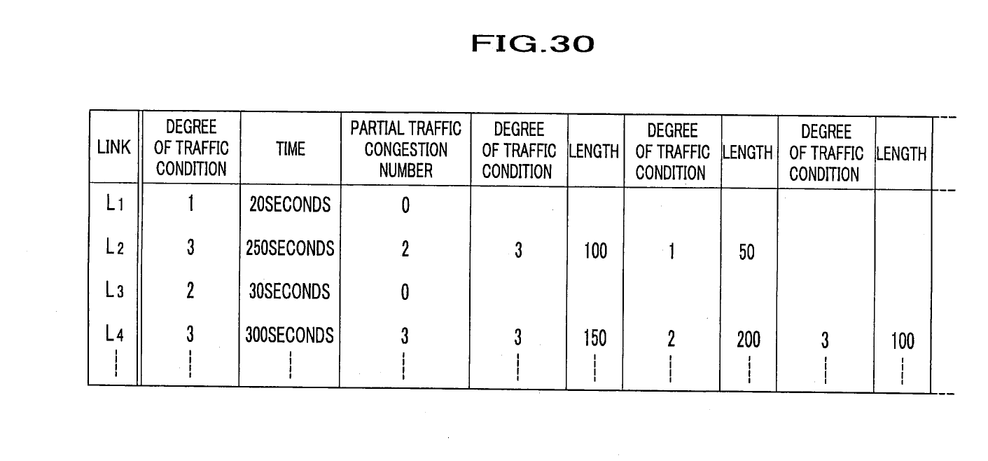

Moreover, an example of the traffic congestion information (traffic congestion data) processed (generated) in the road specification processing part 25 and the traffic data-processing part 27 of the road information receiver 5 of the reception side is shown in FIG. 30. In the FIG. 30, link L₁ shows two reproduction coordinates like reproduction coordinates N₀ (100,100) to reproduction coordinates N₁ (250,300). Incidentally, as for this link L₁, time required is 20 seconds and the time required of link L₂ is 250 seconds.

That is, the link L₁ from the traffic congestion information (traffic congestion data) correlated with the link Li shown in FIG. 29, and each time required of link L2, a link L3, a link L4 . . . shown in FIG. 30 (link Lᵢ) may be obtained.

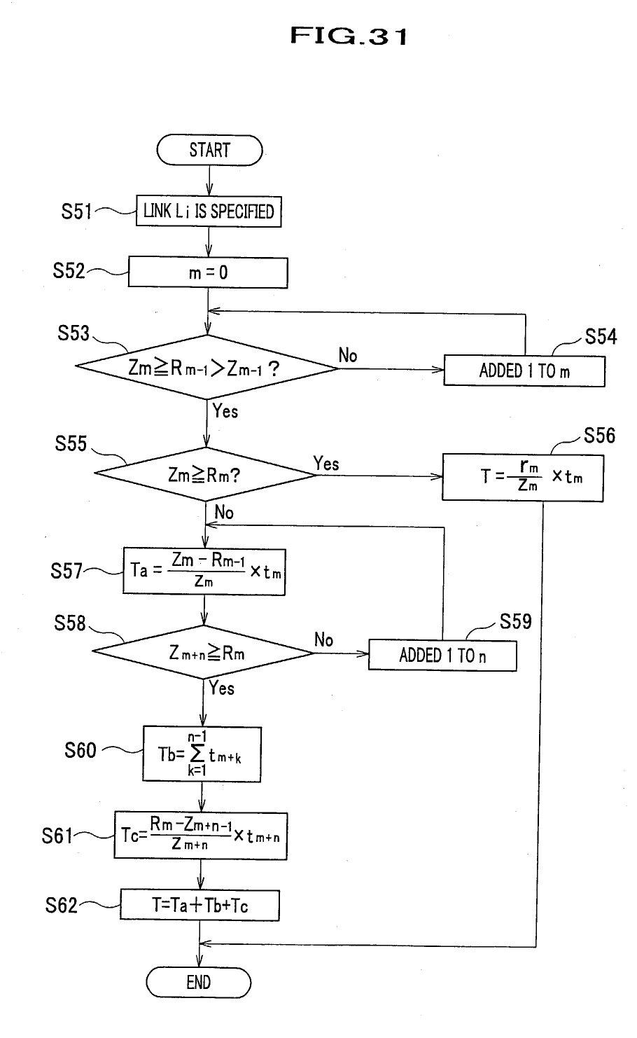

Here, how to obtain the time required between reproduction coordinates (node) (link Lᵢ) from traffic congestion information (traffic congestion data) will be explained with reference to a flow chart shown in FIG. 31.

First, the link Lᵢ for obtaining the time required is specified (S51). Subsequently, m=0 is substituted for m of the cumulative traffic congestion distance Zₘ and the cumulative distance Rₘ (S52). In addition, m=0 is substituted for setting the cumulative traffic congestion distance Zₘ and cumulative distance Rₘ to 0, and for obtaining the traffic congestion information (traffic congestion data) correlated with Link Li from a main base point (reproduction coordinates of the origin) of a road.

And it is judged whether cumulative distance Rₘ₋₁ is larger than cumulative traffic congestion distance Zₘ₋₁, and below the cumulative traffic congestion distance Zₘ (S53). 1 is added to m until it judges that the cumulative distance Rₘ₋₁ is larger than the cumulative traffic congestion distance Zₘ and below the cumulative traffic congestion distance Zₘ₋₁ (S53, No) (S54). When it is judged that the cumulative distance Rₘ₋₁ is larger than the cumulative traffic congestion distance Zₘ and below the cumulative traffic congestion distance Zₘ₋₁ (S53, Yes), it is judged whether the cumulative distance Rₘ is below the cumulative traffic congestion distance Zₘ (S55). When judged that the cumulative distance Rₘ is below the cumulative traffic congestion distance Zₘ (S55, Yes), the link Li is included in the cumulative traffic congestion distance Zₘ₋₁ to cumulative traffic congestion distance Zₘ, and the time required T of Link Li is computed by rₘ/zₘ×tₘ (S56). Moreover, when not judged that the cumulative distance Rₘ is below the cumulative traffic congestion distance Zₘ in S55 (S55, No), the time required Ta from cumulative distance Rₘ₋₁ to the cumulative traffic congestion distance Zₘ is computed by Ta=(Zₘ−Rₘ−1)/zₘ×tₘ (S57) first. And it is judged whether the cumulative distance Rₘ is below the cumulative traffic congestion distance Zₘ₊ₙ (S58). In addition, the initial value of n is 1. 1 is added to n until it is judged that the cumulative distance Rₘ is below the cumulative traffic congestion distance Zₘ₊ₙ (S58, No) (S59). When judged that the cumulative distance Rₘ is below the cumulative traffic congestion distance Zₘ₊ₙ (the initial value of n is 1) (S58, Yes), the time required Tb from the cumulative traffic congestion distance Zₘ to the cumulative traffic congestion distance Zₘ₊ₙ₋₁ is computed as sum total time from time required tₘ₊₁ to time required tₘ₊ₙ₋₁ (S60). And the time required Tc from cumulative traffic congestion distance Zₘ₊ₙ₋₁ to cumulative distance Rₘ is computed by Tc=(Rₘ−Zₘ₊ₙ₋₁)/Zₘ₊ₙ×tₘ₊ₙ (S61). Then, the time required T of Link Li is computed by T=Ta+Tb+Tc (S62).

By the above, the time required can be obtained from the traffic congestion information (congestion data), however long the link Lᵢ may be. In addition, the traffic condition degree jᵢ of the link Li consists of pluralities of traffic condition degree j₁ to traffic condition degree jₘ₊ₙ. The traffic condition degree jᵢ of this whole link Lᵢ (traffic condition degree j₁ to the traffic condition degree jₘ₊ₙ are averaged) is computable by distance rᵢ of the time required T×link Lᵢ of 3600/link Lᵢ. Incidentally, this value (3600/T×rᵢ) serves as traffic condition degree 3 in the range of 0 m to 10000 m, in 10000 m to 20000 m, it becomes the traffic condition degree 2, and in larger range than 20000 m, it becomes the traffic condition degree 1.

(Result Compared with the Present Method [VICS] and Various Encoding Methods).

Next, with reference to FIG. 32, the result of comparing the road information transmission and reception system 1 explained by this embodiment, and the present method (VICS) will be explained with reference to FIG. 32.

The result of comparing the road information transmission and reception system as explained in this embodiment and the present method (VICS) will be explained. Each item and amount of information of the compared present method (VICS) are 12 bits of the VICS link, 2 bits of the traffic condition degree, 2 bits of an extended flag, and 16 bits (coordinates of a traffic congestion head position, the length of traffic congestion, respectively 8 bits) of extended information.

In the secondary mesh 533935 shown in lower part of FIG. 32, since it is 482 bytes of link number, and 127 bytes of partial traffic congestion, all transmission data is as follows. The information of 16 bits of subtotals of the VICS link, the traffic condition degree, and an extended flag is required to 482 bytes of all links, and 16 bits of extended information are required to 127 bytes of partial traffic congestion.□ When these are calculated, 482×16+127×16=9744 bits is obtained.□ Since 1 byte includes 8 bits, 9744 bits becomes 1218 bytes (the present amount of information). The road information transmission and reception system 1 explained by this embodiment, includes 739 bytes (amount of information of this method). This means that data-transmission amount becomes 60 percent as compared with the present method (VICS), reducing 40 percent.

This effect is achieved by fewer number of bits allocated to the location data of the road information transmission and reception system 1 (specifically the position of a road is indicated by element coordinates) than the number of bits allocated to the VICS link of the present method, in order to indicate the position of a road.

Furthermore, even when VICS link is used, the VICS link can be divided into arbitrary length (can be divided into continuous arbitrary number of the VICS link) according to the traffic condition (traffic congestion information contained in traffic data □congestion data□). This makes it possible to transmit the road information or the like dynamically.

Furthermore, the traffic congestion information (congestion data) included in traffic data is transmitted as continued information (the number is reduced) without dividing the traffic congestion information (traffic congestion data) included in traffic data for every VICS link. This enables the number of bits to be reduced to thereby reduce data-transmission amount also.

Next, comparison of each information on various systems for encoding traffic congestion information (traffic congestion data) using the normalized coordinates of secondary mesh units, and the amount of information is explained with reference to FIG. 33. The information shown in this FIG. 33 is transmitted from a transmission side in the secondary mesh 533935 in 17:00 on June 15.

The system which encodes traffic congestion information (traffic congestion data) using the normalized coordinates of secondary mesh unit as shown in FIG. 33 includes a traffic congestion link system, a road link system, and a bi-directional angular difference system, to thereby compare these systems and the road information transmission and reception system 1. Since a traffic congestion link system is a system, which uses normalized coordinates for every unit of traffic congestion, the amount of information is increased most in the system shown in the FIG. 33 (1962 bytes).

A road link system is a system, which divides the road coordinates and the traffic congestion showing the position of a road, so as to be encoded.

A bi-directional angular difference system shows all the road coordinates continuing into the road coordinates of the head showing the start of a road in the road coordinates showing the position of a road, by an angle and distance□and also the amount of information is encoded to 1 K byte or less when bi-directional road is changed into only one-way road.

This system (system by the road information transmission and reception system 1) uses element coordinates, and it is the system which thinned out the number of coordinates. As shown in FIG. 33, it is the smallest amount of information. Incidentally, the interval of element coordinates is made into about 2000 m by this system. If it is an interval of this level, while being able to lessen the amount of information (data-transmission capacity) transmitted from a transmission side, the position of a road can be indicated correctly at the reception side.

Finally, a secondary mesh will be explained with reference to FIG. 34.

Location data (element coordinates) used in this embodiment is grid coordinates corresponding to latitude longitude. The grid coordinates are obtained by determining a fixed frame on surface of the earth, and dividing the inside of this frame into division into equal parts. The grid coordinates are mentioned as a primary mesh, a secondary mesh, and normalized coordinates. For example, a primary mesh divides the direction of longitude in 1 degree, and divides the direction of latitude in 40 minutes. Or the secondary mesh equally divides the primary mesh into eight respectively in the direction of longitude, and in the direction of latitude further, as shown in FIG. 34. Consequently, it can be said that the secondary mesh divides the primary mesh into 64 pieces.

Moreover, as shown in FIG. 34, a main base point of the primary mesh shall be a lower left position in FIG. 34, longitude shall be from longitude 120 degrees east to 121 degrees, and latitude 30 degrees north to 30 degrees 40 minutes.□ Then, as for the secondary mesh, when the m-th direction of longitude, and the n-th direction of latitude are determined, the main base point of the secondary mesh becomes 120 degrees+□m−1□×1□8, 30 degrees+(n−1)×1□8×40 minutes.

Furthermore, if the inside of a secondary mesh is divided equally into P and Q, the main base point of coordinates is as follows.

120 degrees+(m−1)×1□8+1□8×(P−1)□10000 degrees, 30 degrees+(n−1)×1□8×40 minutes+5 minutes□10000, that is, 30 degrees (5×(n−1)+(5×Q)□10000) minutes.

Thus, conversion of grid coordinates and longitude latitude can be performed. In this embodiment, Grid coordinates indicate the secondary mesh and the coordinates of details are shown using normalized coordinates. Thus, the method for reducing the number of digits is used. That is, since the primary mesh and the secondary mesh can be omitted without specifying point by point, location data can be shown by the small amount of information (the number of bits).

As described above, this invention was explained based on one embodiment. However, this invention is not limited thereto.

For example, it can be regarded as a road information transmitting program and a road information reception program which describe processing of each constitution of road information transmitter 3 and the road information receiver 5 in a general-purpose computer language and a general-purpose machine language. Moreover, it is also possible to consider that processing of each road information transmitter 3 and road information receiver 5 consist of every one process, constituting the road information transmitting method, and the road information receiving method. The same effect as road information transmitter 3 and the road information receiver 5 can be obtained in these cases.

Moreover, supplementary explanation will be given about the example of application of the road information transmission and reception system 1 (road information transmitter 3 and road information receiver 5) explained in this embodiment.

In this road information transmission and reception system 1, element coordinates have been treated per secondary mesh. However it can be designed widely or narrowly rather than this unit. For example, since the highway consists of comparatively simple form and is connected broadly, dealing with element coordinates in the unit of a primary mesh (about 80 km around) is possibly adopted.

In this case, since division loss decreases compared with dividing the geographical feature on surface of the earth in a secondary mesh, increase in efficiency of that part and data-transmission capacity is expectable.

Wherein, since area becomes large compared with a secondary mesh in case of a primary mesh, the number of digits showing coordinates will increase. However, if it is comparatively simple form like a highway, middle element coordinates are reducible. In addition, middle element coordinates are shown by coordinates and the direction and a method for omitting the distance between element coordinates is included. Moreover, accuracy with the expensive data showing the direction of the middle element coordinates is not required. Therefore, when showing the direction of 360 degrees per 6 times, it will be good by 60 data (6 bits), for example.

Furthermore, in the road matching processing in the road specification processing part 25 of the road information receiver 5 of reception side, in this embodiment, map coordinates data located in near most for every decoded coordinates (element coordinates) is made into reproduction coordinates. However, when decoded coordinates are in the range where the judgment of the reproduction coordinates is difficult, statistics processing that distribution such as 0.5, 0.5, or 0. 3, 0.7 is given to not only one decoded coordinate but two decoded coordinates is performed to calculate the amount of statistics. Thus, the method for indicating the road where the amount of statistics is increased most can also be proposed. As described above, optimal data display (for example, to use a primary mesh) and bit constitution of a code (for example, the constitution where middle element coordinates are shown by coordinates and direction) can be performed.

What is claimed is:

1. A road information transmitter for transmitting road information which contains location data showing the position of a road, including:
an element coordinates record part where element coordinates for indicating the position of a road by at least two coordinates of origin and destination of the map coordinates data for indicating a position by coordinates, are recorded as the location data;
an encoding part that encodes the element coordinates recorded in the element coordinates record part to generate code coordinates;
a modulation part that modulates the code coordinates encoded by the encoding part to generate a modulation signal; and
a transmitting part that transmits the modulation signal modulated by the modulation part, as the road information.

2. A road information transmitter for transmitting road information which contains location data showing the position of a road, and traffic data showing a traffic condition of the road, including:
a traffic data collecting part that collects traffic data;
an element coordinates record part where element coordinates for indicating the position of a road are recorded as the location data by at least two coordinates of origin and destination of map coordinates data for indicating the position by coordinates as the location data;
an encoding part that generates code coordinates obtained by encoding the element coordinates and traffic data code obtained by encoding the traffic data, wherein the element coordinates recorded in the element coordinates record part and the traffic data are correlated;
a modulation part that modulates the code coordinates and the traffic data code encoded by the encoding part to generate a modulation signal; and
a transmitting part that transmits the modulation signal modulated by the modulation part, as the road information.

3. A road information transmitting method for transmitting road information, which contains location data showing the position of a road, including the steps of:
encoding element coordinates for indicating the position of a road by at least two coordinates of origin and destination of map coordinates data for indicating a position by coordinates, wherein the element coordinates are read out from a record part in which the element coordinates have been recorded beforehand as the location data;
modulating the code coordinates encoded in the encoding step to generate a modulation signal; and
transmitting the modulation signal modulated in the modulation step, as the road information.

4. A road information transmitting method for transmitting road information that contains location data showing the position of a road, and a traffic data showing the traffic condition of the road, including the steps of:
collecting traffic data from a detection part provided on the road;
encoding element coordinates for indicating the position of a road by at least two coordinates of origin and destination of map coordinates data for indicating a position by coordinates, and the traffic data to generate code coordinates obtained by encoding the elements coordinates and the traffic data code obtained by encoding the traffic data, wherein the element coordinates are read out from a record part in which the elements coordinates have been recorded beforehand as the location data, and wherein the element coordinates and the traffic data are correlated; and
modulating the code coordinates and the traffic data code encoded at the coding step.

5. A road information transmitting program, functionally equipped with:
an encoding part that encodes the element coordinates recorded in the element coordinates record part to generate code coordinates, wherein the element coordinates are read out from a record part in which the elements coordinates have been recorded beforehand as the location data;
a modulation part that encodes the element coordinates recorded in the element coordinates record part to generate code coordinates; and
a transmitting part that transmits the modulation signal modulated by the modulation part, as the road information.

6. A road information transmitting program, functionally equipped with a part for transmitting the road information containing the location data showing the position of a road and a traffic data showing the traffic condition of the road, wherein
a traffic data collecting part that collects traffic data from the detection part provided on the road;
an encoding part that encodes the element coordinates recorded in the element coordinates record part to generate code coordinates, wherein the element coordinates are read out from a record part in which the elements coordinates have been recorded beforehand as the location data, and wherein the element coordinates and the traffic data are correlated;
a modulation part that modulates the code coordinates and the traffic data code encoded by the encoding part to generate a modulation signal; and
a transmitting part that transmits the modulation signal modulated by the modulation part, as the road information, are included.

7. A road information receiver to receive the modulation signal transmitted from the road information transmitter as described in claim 1 as the road information, so as to indicate the position of the road, which includes
a receiving part that receives the modulation signal;
a demodulation part that collects the code coordinates included in the modulation signal by demodulating the modulation signal received by this receiving part;
a decoded coordinates generation part that generates the decoded coordinates by decoding the code coordinates obtained by the decoding part;
a map coordinates data record part where the map coordinates data for indicating a position by coordinates is recorded; and
a road specification processing part that generates reproduction coordinates which indicate the position of a road based on the map coordinates data recorded in this map coordinates data record part, and decoded coordinates generated by the decoded coordinates generation part.

8. A road information receiver to output the processing information processed based on the traffic data included in the road information, while receiving the road information transmitted from the road information transmitter as described in claim 2, and indicating the position of a road, which includes
a receiving part that receives the modulation signal;
a modulation part that collects the code coordinates and the traffic data code included in the modulation signal by demodulating the modulation signal received by this receiving part;
a decoded coordinates generation part that generates the traffic data by decoding the decoded coordinates and the traffic data code by decoding the code coordinates obtained by the demodulation part;
a map coordinates data record part where the map coordinates data for indicating a position by coordinates is decoded;
a road specification processing part to generate the reproduction coordinates which indicate the position of a road based on the map coordinates data recorded in the map coordinates data record part, and the decoded coordinates generated by the decoded coordinates generation part; and
a traffic data-processing part to output the processing information processed at least either of the processing of route selection processing to choose the route which serves as the shortest time based on the position and the traffic data of the road indicated by this road specification processing part when moving on the road, and the display processing which enables the display of the traffic condition of the road on the display part.

9. A road information receiving method for receiving the modulation signal transmitted using the road information transmitting method as described in claim 3 as a road information so as to indicate the position of the road, including the steps of:
receiving the modulation signal;
obtaining the code coordinates included in the modulation signal by demodulating the modulation signal received at the receiving step;
generating the decoded coordinates by decoding the code coordinates obtained at the decoding step; and
generating reproduction coordinates which indicate the position of a road based on the map coordinates data which has been recorded in the record part beforehand, and which indicates a position by coordinates and the decoded coordinates generated at the decoded coordinates generation step, to specify the road.

10. A road information receiving method to output the processing information processed based on the traffic data included in the road information, while receiving the road information transmitted using the road information transmitting method as described in claim 4, including:
a receiving part for receiving the modulation signal;
a demodulation part for demodulating the modulation signal received at the receiving part to obtain the code coordinates included in the modulation signal, and traffic data;
a decoded coordinates generation part for generating decoded coordinates obtained by decoding the code coordinates collected by the demodulation step, and traffic data obtained by decoding traffic data code; and
a road specification processing part for generating reproduction coordinates which indicate the position of a road based on the map coordinates data which is recorded in the record part beforehand, and the decoded coordinates generated by the decoded coordinates generation part, to indicate a position by coordinates; and
a traffic data-processing part for outputting the processing information processed at least either of the route selection processing for choosing the route which serves as the shortest time based on the position and the traffic data of the road indicated by the road specification processing part when moving on the road, and the display processing which enables the display of the traffic condition of the road on a display.

11. A road information reception program, functionally equipped with a part where the modulation signal transmitted as road information is received, and the position of a road is indicated, which includes:
a receiving part that receives the modulation signal;
a demodulation part that demodulates the modulation signal to obtain the code coordinates included in the modulation signal received at this receiving part;
a decoded coordinates generation part that generates the decoded coordinates which decoded the code coordinates obtained by the demodulation part;
a road specification processing part for generating reproduction coordinates which indicate the position of a road based on the map coordinates data which has been recorded in a record part beforehand, and reproduction coordinates generated in the decoded coordinates generating part for indicating the position of a road.

12. A road information reception program, functionally equipped with a part for outputting the processing information processed based on the traffic data contained in the road information, while receiving the road information transmitted by the road information transmitting program as described in claim 6 functioning, and indicating the position of the road, which includes:
a receiving part that receives the modulation signal;
a demodulation part that demodulates the modulation signal to obtain the code coordinates included in the modulation signal received at this receiving part and the traffic data code;
a decoded coordinates generation part that generates the traffic data which decoded the decoded coordinates and the traffic data code which decoded the code coordinates obtained by the demodulation part;
a road specification processing part that generates the reproduction coordinates which indicate the position of a road based on the map coordinates data which is recorded in record part beforehand, and which indicates a position of a road by coordinates, and the decoded coordinates generated by the decoded coordinates generation part; and
a traffic data-processing part for outputting the processing information processed at least either of the route selection processing for choosing the route which serves as the shortest time based on the position and the traffic data of the road indicated by the road specification processing part when moving on the road, and the display processing which enables the display of the traffic condition of the road on a display.
